(19) United States
(12) Patent Application Publication
(10) Pub. No.: US 2025/0390060 A1
(43) Pub. Date: Dec. 25, 2025

(54) PRINTING APPARATUS

(71) Applicant: BROTHER KOGYO KABUSHIKI KAISHA, Nagoya (JP)

(72) Inventors: Taichiro KIMOTO, Nagoya (JP); Tetsunori MORI, Kariya (JP); Nobumasa TANAKA, Nagoya (JP)

(73) Assignee: BROTHER KOGYO KABUSHIKI KAISHA, Nagoya (JP)

(21) Appl. No.: 19/208,734

(22) Filed: May 15, 2025

(30) Foreign Application Priority Data
Jun. 24, 2024 (JP) 2024-101145

(51) Int. Cl. G03G 21/18; B41J 2/175

(52) U.S. Cl. CPC G03G 21/1882; B41J 2/17546; G03G 2221/1823; G03G 2221/1838

(57) ABSTRACT

A printing apparatus includes a replaceable component, an attachment case configured to hold the replaceable component removably installed thereto, and a controller. The replaceable component includes a chamber configured to store a consumable material used for printing, and a memory configured to store consumable initial-state information regarding an initial state of the consumable material. The controller is configured to retrieve the consumable initial-state information from the memory of the replaceable component installed in the attachment case, and to perform consumable processing related to the consumable material based on the retrieved consumable initial-state information.

### REFERENCE TO RELATED APPLICATIONS

This application claims priority from Japanese Patent Application No. 2024-101145 filed on Jun. 24, 2024. The entire content of the priority application is incorporated herein by reference.

### BACKGROUND ART

Heretofore, various techniques have been proposed for managing consumables used in apparatuses. For instance, a technique has been disclosed for storing destination-related information in an EEPROM of a cartridge. The EEPROM in this known technique stores “shipping destination” data, which is used to control printing operations in a printer. When a cartridge is installed in the printer, the printer reads the “shipping destination” data stored in the EEPROM of the installed cartridge before performing a printing operation and determines whether the shipping region of the cartridge matches the shipping region of the printer.

### SUMMARY

To determine the replacement timing of consumable components such as cartridges, it is necessary to manage the amount of ink or toner contained in each consumable component in its initial state. In a configuration where selectable initial amounts of consumables are stored as fixed values in the printer, and a specified amount is set based on information on the installed cartridge, updating the firmware of the printer or performing similar operations would be required if a new selectable amount needs to be added or an existing one needs to be modified after the printer has been released. As a result, each time the selectable amounts are changed or updated, the user's workload increases due to the necessary corresponding tasks.

Aspects of the present disclosure are advantageous in providing one or more improved techniques for a printing apparatus that reduces user workload when information regarding consumables is updated.

According to aspects of the present disclosure, a printing apparatus is provided, which includes a replaceable component, an attachment case, and a controller. The replaceable component includes a chamber configured to store a consumable material used for printing. The replaceable component further includes a memory configured to store consumable initial-state information regarding an initial state of the consumable material. The attachment case is configured to hold the replaceable component removably installed thereto. The controller is configured to retrieve the consumable initial-state information from the memory of the replaceable component installed in the attachment case. The controller is further configured to perform consumable processing related to the consumable material based on the retrieved consumable initial-state information.

### BRIEF DESCRIPTION OF DRAWINGS

FIG. 1A is an external perspective view showing a printer in a closed state with a cover closed.

FIG. 1B is an external perspective view showing the printer in an open state with the cover opened.

FIG. 2 is a schematic diagram illustrating an internal configuration of the printer.

FIG. 3 is a block diagram illustrating an electrical configuration of the printer.

FIG. 4 is a block diagram illustrating an electrical configuration of an IC board.

FIG. 5 illustrates two example graphs corresponding to two types of equilibrium calculation parameters, with each graph showing a relationship between the remaining amount of ink in a sub-tank and the total amount of ink, and further illustrates the states of the ink in a cartridge and the sub-tank.

FIG. 6 is a flowchart showing a procedure of cartridge processing.

FIGS. 7A, 7B, and 7C are flowcharts showing a procedure of a CTG authentication process.

FIG. 8 is a flowchart showing a procedure of an equilibrium calculation process.

FIG. 9 is a flowchart showing a procedure of a remaining amount subtraction process.

FIG. 10 is a flowchart showing a procedure of an ink information display process.

FIG. 11 is a flowchart showing a procedure of a reset process.

### DESCRIPTION

It is noted that various connections are described between elements in the following description. These connections, unless specified otherwise, may be either direct or indirect, and this specification is not intended to be limiting in that respect. Aspects of the present disclosure may be implemented using circuits (such as application-specific integrated circuits) or computer software stored on computer-readable media, including but not limited to RAMs, ROMs, flash memories, EEPROMs, CD media, DVD media, temporary storage, hard disk drives, floppy drives, permanent storage, and the like.

As used herein, the term “processor” encompasses a single processor or a group of multiple processors, which may include a single-core processor, a multi-core processor, multiple processors within a single device, or multiple processors in wired or wireless communication with each other. Such processors may be locally or remotely distributed and may operate collaboratively or in a distributed fashion across a network of devices, the Internet, or the cloud to collectively perform the tasks attributed to the “processor” described herein. Similarly, the term “non-transitory computer-readable storage medium” encompasses a single storage medium or a group of multiple storage media, which may be locally or remotely distributed and may collectively store and provide access to instructions, data, or other information in a coordinated or distributed manner.

In the present disclosure, an inclusive OR, meaning that it includes either A or B or both, may be expressed as “A and/or B,” “at least one of A or B,” or “at least one selected from the group consisting of A and B.” The same applies to a case where there are three or more selectable elements to consider.

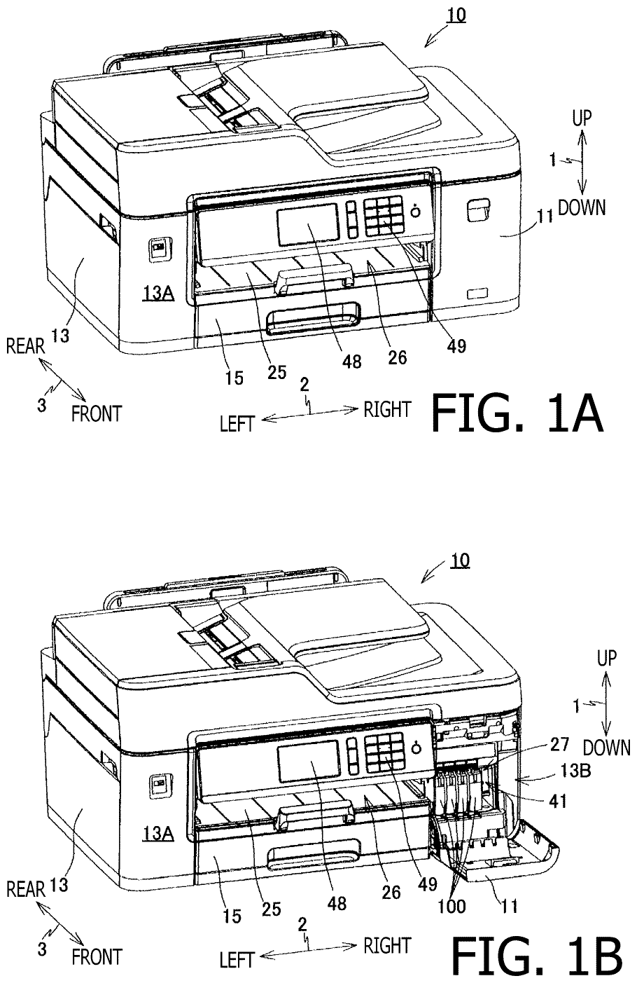

The following describes a printing apparatus in an illustrative embodiment according to aspects of the present disclosure. It is noted that the illustrative embodiment described below is merely an example of the present disclosure, and it goes without saying that modifications may be made as appropriate within a scope that does not alter the gist of the present disclosure. FIGS. 1A and 1B are perspective views of a printer 10 in the illustrative embodiment. FIG. 1A shows a closed state in which a cover 11 is closed. FIG. 1B shows an open state in which the cover 11 is open. In the following description, as shown in FIGS. 1A and 1B, vertical directions 1 (i.e., upward and downward), left-right directions 2 (i.e., leftward and rightward), and front-rear directions 3 (i.e., frontward and rearward) are defined based on the printer 10 as viewed from the front. Hereinafter, for explanatory convenience, a representative one of the vertical directions 1 may simply be referred to as “the vertical direction 1.” The same applies to the left-right directions 2 and the front-rear directions 3.

### Overview of Printer

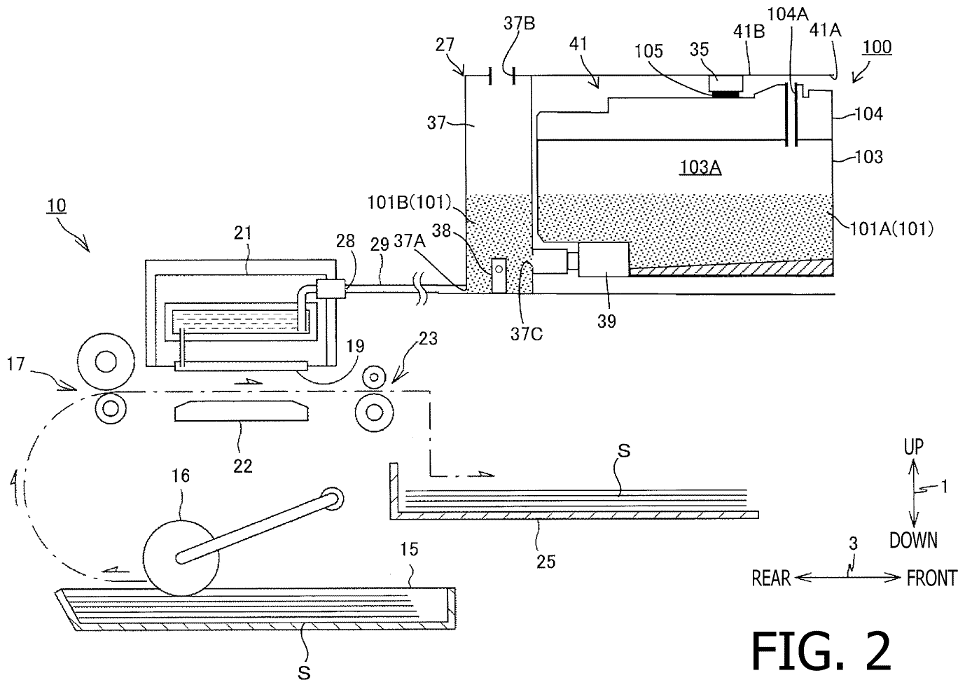

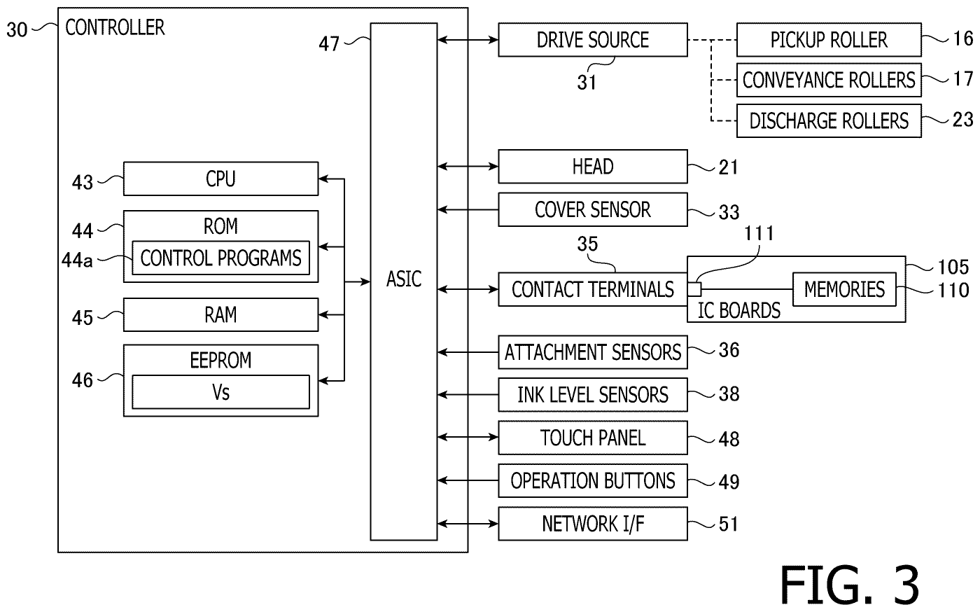

FIG. 2 schematically illustrates an internal configuration of the printer 10. As shown in FIGS. 1A, 1B, and 2, the printer 10 is configured to print images on sheets using an inkjet method. The printer 10 includes a substantially rectangular housing 13. In the housing 13, the printer 10 further includes a feed tray 15, a pickup roller 16, conveyance rollers 17, a head 21 with a plurality of nozzles 19, a platen 22 facing the head 21, discharge rollers 23, a discharge tray 25, an attachment case 27 configured to hold cartridges 100 detachably installed thereto, tubes 29, a controller 30 (see FIG. 3), and a drive source 31 (see FIG. 3). Each tube 29 communicably connects a connection portion 28 of the head 21 to a corresponding sub-tank 37 of the attachment case 27, which will be described later.

The drive source 31 includes, for instance, a motor and a reduction gear coupled to an output shaft of the motor. The drive source 31 is configured to drive and rotate the pickup roller 16, the conveyance rollers 17, and the discharge rollers 23. The printer 10 activates the drive source 31 to rotate the pickup roller 16 and the conveyance rollers 17, thereby conveying a sheet S stored in the feed tray 15 to a position of the platen 22. The printer 10 ejects ink 101, which is supplied from the cartridges 100 installed in the attachment case 27 via the tubes 29, through the nozzles 19 of the head 21. For instance, the printer 10 includes a carriage configured to reciprocate along a main scanning direction, which intersects a conveyance direction in which the sheet S is conveyed by the conveyance rollers 17. The head 21 is mounted on the carriage. The printer 10 causes the head 21 to eject the ink 101 from the nozzles 19 while moving the carriage from one end to the other in the main scanning direction. As a result, the ink 101 lands on the sheet S supported on the platen 22, and an image is formed on the sheet S. The image is printed in an area on the sheet S that faces the head 21 and corresponds to a single pass. Next, the printer 10 conveys the sheet S using the conveyance rollers 17 to a position where a next area to be printed faces the head 21. By repeatedly executing these processes alternately, the printer 10 prints images of a plurality of passes on the single sheet S. The printer 10 rotates the discharge rollers 23 to discharge the printed sheet S onto the discharge tray 25. The sheet S discharged onto the discharge tray 25 is retrievable through an opening 26 formed in a front face 13A of the printer 10.

As shown in FIG. 1B, an opening 13B is formed at a right end portion of the front face 13A of the housing 13. The housing 13 includes a cover 11 configured to move between an open state (see FIG. 1B), where the opening 13B is open, and a closed state (see FIG. 1A), where the opening 13B is closed. Specifically, the cover 11 is configured to rotate about its lower end portion relative to the housing 13, thereby switching between the open state and the closed state. The attachment case 27 (including storage compartments 41, described below) is positioned in a space extending beyond the opening 13B inside the housing 13.

The printer 10 further includes a cover sensor 33 (see FIG. 3). For instance, the cover sensor 33 may be a mechanical sensor, such as a switch configured to detect whether the cover 11 is in contact with or separated from the switch. In another instance, the cover sensor 33 may be an optical sensor configured to detect whether light is blocked or transmitted depending on the position of the cover 11. The cover sensor 33 outputs different signals to the controller 30 (see FIG. 3) depending on the position of the cover 11. For instance, when the cover 11 is in the closed state, the cover sensor 33 outputs a low-level signal to the controller 30. Conversely, when the cover 11 is in a position other than the closed state, the cover sensor 33 outputs a high-level signal, which has a higher signal level than the low-level signal, to the controller 30. Thus, the controller 30 is enabled to detect whether the cover 11 is in the open state or the closed state based on the detection signal from the cover sensor 33.

As shown in FIGS. 2 and 3, the attachment case 27 includes contact terminals 35, attachment sensors 36 (see FIG. 3), sub-tanks 37 (see FIG. 2), ink level sensors 38, and joints 39 (see FIG. 2). The attachment case 27 is configured to accommodate four cartridges 100, each corresponding to one of four colors of black (K), cyan (C), magenta (M), and yellow (Y). Specifically, the attachment case 27 includes the four contact terminals 35, the four attachment sensors 36, the four sub-tanks 37, the four ink level sensors 38, and the four joints 39, each associated with one of the four cartridges 100. These four sets of contact terminals 35, attachment sensors 36, sub-tanks 37, ink level sensors 38, and joints 39 have substantially the same configuration except for differences in color of the ink 101. Accordingly, in the following description, a single set of components for one ink color is explained. It is noted that the number of cartridges 100 attachable to the attachment case 27 is not limited to four and may be one, five, or more.

The attachment case 27 is formed in a box shape and includes the storage compartments 41. Each storage compartment 41 is configured to accommodate an installed cartridge 100. The storage compartments 41 are partitioned by walls that define their top, bottom, left, right, and rear sides. Each storage compartment 41 has an opening 41A formed on its front side. The opening 41A of each storage compartment 41 is in communication with the opening 13B of the housing 13. Accordingly, when the cover 11 is in the open state, the opening 41A of each storage compartment 41 in the attachment case 27 is exposed to the outside of the printer 10 through the opening 13B of the housing 13. The cartridge 100 is inserted through the opening 13B of the housing 13 in the rearward direction of the front-rear directions 3 and installed in the attachment case 27. The cartridge 100 is pulled in the frontward direction of the front-rear directions 3 and removed from the attachment case 27 through the opening 13B.

Each cartridge 100 includes a housing 103 and a lid 104. Inside the housing 103, a liquid chamber 103A is formed to store ink 101. An upper portion of the liquid chamber 103A is closed by the lid 104. An IC board 105, on which a memory 110 is mounted, is disposed on the lid 104. Examples of the memory 110 may include, but are not limited to, rewritable non-volatile memories such as an EEPROM and a flash memory.

The contact terminal 35 is attached, for instance, to an upper wall 41B of the storage compartment 41. The contact terminal 35 is positioned in contact with an electrode (see FIG. 3) disposed on the IC board 105 of the cartridge 100 when the cartridge 100 is installed in the attachment case 27. The contact terminal 35 is electrically connected to the controller 30 (see FIG. 3) of the printer 10. The electrode 111 is exposed on an upper surface of the IC board 105 and is configured to conductively connect with the contact terminal 35. Thus, when the cartridge 100 is installed in the attachment case 27, the electrode 111 establishes an electrical connection with the contact terminal 35. The controller 30 retrieves information from the memory 110 on the IC board 105 via the contact terminal 35 and the electrode 111. Additionally, the controller 30 writes information into the memory 110 on the IC board 105 via the contact terminal 35 and the electrode 111.

It is noted that the terms “acquire,” “obtain,” and “retrieve” as used in the present disclosure do not necessarily require an explicit request. That is, a process in which the controller 30 reads information from the memory 110 without issuing a request may fall within the concept of “the controller 30 acquires (obtains or retrieves) information.” Accordingly, the terms “acquire,” “obtain,” and “retrieve” may encompass both cases in which the controller 30 actively reads information from the memory 110 and cases in which the cartridge 100 outputs information from the memory 110 in response to a power supply.

The attachment sensor 36 is disposed, for instance, on the upper wall 41B of the storage compartment 41. The attachment sensor 36 is a sensor for detecting whether the cartridge 100 is installed in the attachment case 27. For instance, the attachment sensor 36 may be an optical sensor configured to output different signals (e.g., a high-level signal and a low-level signal) to the controller 30, depending on whether it has detected a rib (not shown) disposed on the cartridge 100. Thus, the controller 30 detects the installation of the cartridge 100 based on the detection signal from the attachment sensor 36. It is noted that feasible methods for detecting the installation of the cartridge 100 are not limited to using an optical sensor, but may also include a method using a gear configured to rotate in response to the installation of the cartridge 100.

The attachment case 27 includes four sub-tanks 37, each corresponding to one of the four cartridges 100. Each sub-tank 37 is positioned further rearward than the rear wall of the corresponding storage compartment 41. Each sub-tank 37 is enclosed by six walls that partition its top, bottom, left, right, front, and rear. Each sub-tank 37 is configured to store ink 101. In the following description, when distinguishing between ink 101 stored in the liquid chamber 103A of the cartridge 100 and ink 101 stored in the sub-tank 37, the ink stored in the liquid chamber 103A may be referred to as “first ink 101A,” and the ink stored in the sub-tank 37 may be referred to as “second ink 101B.” When referring collectively to both types of ink stored in these different locations, they may simply be referred to as “ink 101.”

The ink level sensor 38 is disposed on the bottom wall of the sub-tank 37. The ink level sensor 38 is configured to output different signals to the controller 30 depending on whether the amount of the second ink 101B stored in the sub-tank 37 has decreased below a particular amount. For instance, when the amount of the second ink 101B is equal to or greater than the particular amount, and the liquid surface of the second ink 101B is positioned at or above the detection position of the ink level sensor 38, the ink level sensor 38 outputs a low-level signal to the controller 30. Conversely, when the amount of the second ink 101B is less than the particular amount, and the liquid surface of the second ink 101B is positioned below the detection position of the ink level sensor 38, the ink level sensor 38 outputs a high-level signal to the controller 30. Accordingly, the controller 30 detects whether the amount of the second ink 101B has decreased below the particular amount based on the detection signal from the ink level sensor 38.

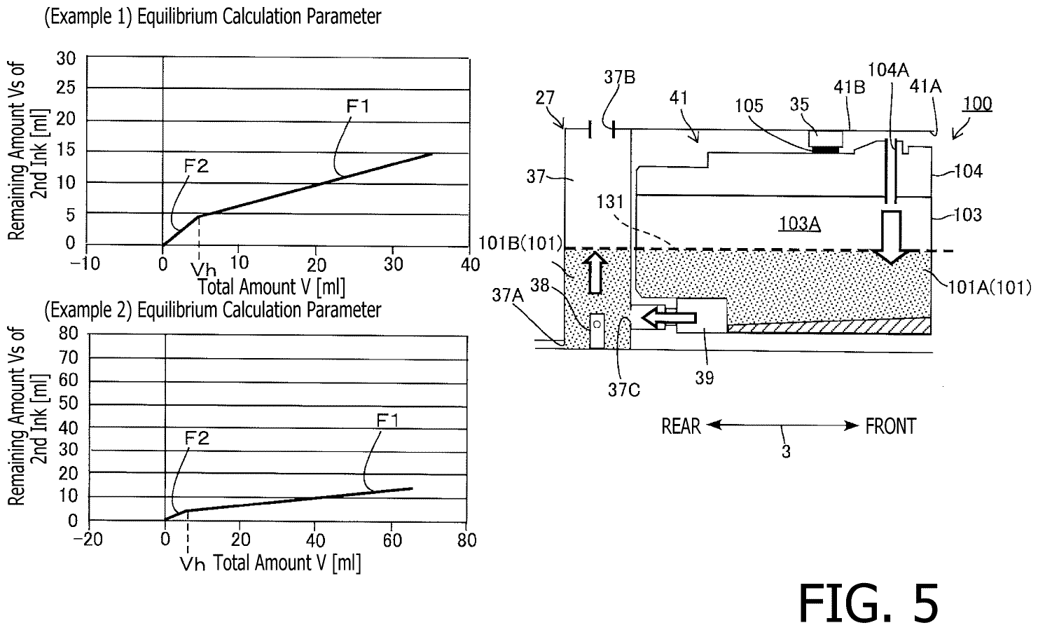

The particular amount corresponds, for instance, to an amount sufficient for printing approximately several hundred sheets S. Additionally, when the amount of the second ink 101B decreases below the particular amount, the cartridge 100 becomes empty. Thus, the printer 10 is enabled to continue printing approximately several hundred sheets, even after the cartridge 100 becomes empty as the liquid surface 131 (see FIG. 5) of the ink 101 is positioned below the detection position of the ink level sensor 38. Feasible examples of the ink level sensor 38 may include, but are not limited to, an electrode-type ink level sensor, an ultrasonic liquid level sensor, and other types of sensors. For instance, the electrode-type ink level sensor may have two electrodes and may be configured to detect whether or not the amount of the ink stored in the sub-tank 37 is equal to or greater than the particular amount based on the conductive state between the two electrodes.

An outlet port 37A is formed in the rear wall of each sub-tank 37. The outlet port 37A is disposed at a lower end portion of the rear wall and is communicably connected to the tube 29. Accordingly, each sub-tank 37 communicates with the connection portion 28 of the head 21 via the outlet port 37A and the tube 29. Thus, the second ink 101B stored in each sub-tank 37 is supplied to the head 21 through the outlet port 37A and the tube 29.

An air communication passage 37B is formed in the upper wall of sub-tank 37. The sub-tank 37 is communicably connected to the outside of the printer 10 through the air communication passage 37B and is open to the atmosphere. Additionally, an air communication passage 104A is formed in the lid 104 of the cartridge 100. The liquid chamber 103A of the cartridge 100 is communicably connected to the outside of the cartridge 100 through the air communication passage 104A and is open to the atmosphere. It is noted that the structures of the air communication passages 37B and 104A are not particularly limited as long as they allow the sub-tank 37 and the liquid chamber 103A to be open to the atmosphere. For instance, the sub-tank 37 may include a mechanism (e.g., a spring or a valve) configured to open or close the air communication passage 37B according to whether the cartridge 100 is installed in the attachment case 27. Likewise, the cartridge 100 may include a mechanism (e.g., a spring or a valve) configured to open or close the air communication passage 104A according to whether the cartridge 100 is installed in the attachment case 27.

An inlet port 37C is formed at a lower end portion of the front wall of the sub-tank 37. The inlet port 37C is communicably connected to the housing 103 (more specifically, to the liquid chamber 103A) of the cartridge 100 via the joint 39. The joint 39 includes, for instance, a needle having a flow path for the ink 101, a valve configured to open or close the flow path of the needle, and a coil spring configured to urge the valve. When the cartridge 100 is not installed, the joint 39 positions the valve to close the flow path by the urging force of the coil spring, thereby closing the flow path. When the cartridge 100 is installed in the attachment case 27, the valve is moved against the urging force of the coil spring, thereby opening the flow path and allowing the sub-tank 37 to communicate with the liquid chamber 103A of the cartridge 100.

### Controller

As shown in FIG. 3, the controller 30 includes a CPU 43, a ROM 44, a RAM 45, an EEPROM 46, and an ASIC 47. The ROM 44 stores control programs 44a and other data for the CPU 43 to control various operations. The RAM 45 is used as a storage area for temporarily recording data and signals when the CPU 43 executes the control programs 44a or as a working area for data processing. The EEPROM 46 stores setting information to be retained even after the printer 10 is powered off. For instance, the EEPROM 46 stores a remaining amount Vs, which represents the remaining amount of ink in the sub-tank 37, as will be described later. It is noted that the aforementioned configuration of the memories is merely an example. For instance, the controller 30 may include a flash memory instead of the EEPROM as a non-volatile memory. Additionally, in some cases, the controller 30 executing the control programs 44a may be simply referred to by its device name. For instance, the phrase “The controller 30 drives the motor of the drive source 31 via the ASIC 47” may be understood to mean “The controller 30 executes a control program 44a on the CPU 43 and controls the drive source 31 via the ASIC 47 to drive the motor.”

The ASIC 47 is an Application-Specific Integrated Circuit configured to operate the drive source 31, the head 21, and other components. The controller 30 drives the motor of the drive source 31 via the ASIC 47, thereby rotating the pickup roller 16, the conveyance rollers 17, and the discharge rollers 23. Additionally, the controller 30 outputs a drive signal to a drive element of the head 21 via the ASIC 47, thereby ejecting the ink 101 through the nozzles 19 of the head 21. The ASIC 47 is configured to output a plurality of types of drive signals according to the amount of ink to be ejected through the nozzles 19.

As shown in FIGS. 1 and 3, the printer 10 includes a touch panel 48 and operation buttons 49. The touch panel 48 and the operation buttons 49 are configured to output signals to the ASIC 47 based on a user's input. The touch panel 48 is further configured to change its display contents and present various types of information under the control of the controller 30. It is noted that the aforementioned configuration of the user interface included in the printer 10 is merely an example. For instance, the user interface may include a display such as an LCD (“LCD” is an abbreviation for “Liquid Crystal Display”) and the operation buttons 49, without the touch panel 48.

Additionally, the ASIC 47 is electrically connected to the cover sensor 33, the contact terminals 35, the attachment sensors 36, and the ink level sensors 38. The controller 30 is configured to access the memory 110 on the IC board 105 of each cartridge 100 installed in the attachment case 27 via the contact terminal 35. The controller 30 is further configured to detect the position of the cover 11 via the cover sensor 33. The controller 30 is further configured to detect whether each cartridge 100 is attached or detached via the corresponding attachment sensor 36. The controller 30 is further configured to detect the amount of the second ink 101B in the sub-tank 37 via the ink level sensor 38.

The printer 10 further includes a network I/F (“I/F” is an abbreviation for “interface”) 51. The network I/F 51 is, for instance, a LAN interface. The controller 30 is configured to connect to a PC, the Internet, or a server via the network I/F 51. Feasible examples of the network I/F 51 are not limited to a wired network interface but may also include a wireless network interface.

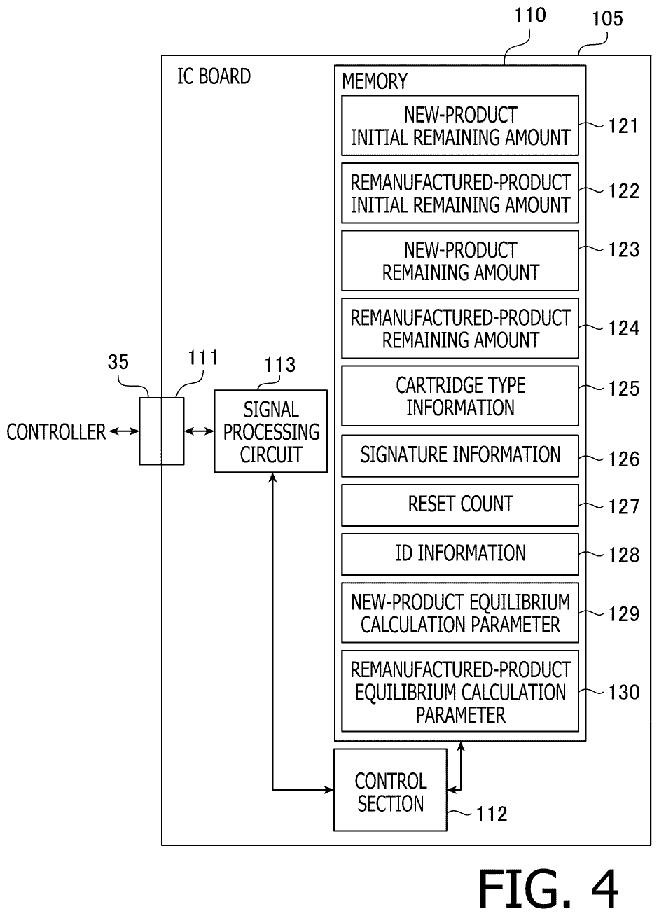

FIG. 4 illustrates a block diagram of the IC board 105. As shown in FIG. 4, the IC board 105 includes, in addition to the memory 110, a control section 112 and a signal processing circuit 113. The control section 112 is connected to the memory 110 and functions as a memory controller that controls the writing of information into the memory 110 and the retrieval of information from the memory 110. The signal processing circuit 113 is connected between the control section 112 and the electrode 111, and is configured to perform the transmission and reception of signals (information) between the control section 112 and the electrode 111.

The memory 110 on the IC board 105 stores a new-product initial remaining amount 121, a remanufactured-product initial remaining amount 122, a new-product remaining amount 123, a remanufactured-product remaining amount 124, cartridge type information 125, signature information 126, a reset count 127, ID information 128, a new-product equilibrium calculation parameter 129, and a remanufactured-product equilibrium calculation parameter 130. For instance, the cartridge 100 may be sold by a cartridge manufacturer (hereinafter, simply referred to as “manufacturer”) and used by a user. Thereafter, the cartridge 100 may be collected, disassembled, cleaned, reassembled, inspected, and have its memory 110 reconfigured by a remanufacturer. Hereinafter, the series of processes described above for the cartridge 100 by the remanufacturer may be referred to as “remanufacturing.” The remanufactured cartridge may then be resold. Accordingly, the term “remanufacturing” in the present disclosure refers to an operation that restores a used replaceable consumable component to its initial state to make it reusable. In the following description, the cartridge 100 sold by the manufacturer is referred to as a “new-product cartridge 100.” Similarly, the cartridge 100 that has been remanufactured by the remanufacturer is referred to as a “remanufactured-product cartridge 100.” It is noted that the manufacturer may also perform remanufacturing. However, in the following description, as an example, the cartridge 100 that has been remanufactured by the manufacturer is not referred to as a “remanufactured-product cartridge 100.” Instead, such a cartridge 100 is regarded as equivalent to a new product and is referred to as a “new-product cartridge 100.” However, the cartridge 100 remanufactured by the manufacturer may alternatively be referred to as a “remanufactured-product cartridge 100.” That is, the processing and handling described below for the remanufactured-product cartridge 100 may also be applied to the cartridge 100 remanufactured by the manufacturer. Accordingly, the entity that performs remanufacturing is not limited to any particular entity. In the following description, as an example, the manufacturer and the remanufacturer are considered separate entities. Additionally, the types and number of data items stored in the memory 110 shown in FIG. 4 are merely examples. For instance, the memory 110 may store a usage history, which includes information about the printer(s) 10 that have used the cartridge(s) 100 in the past.

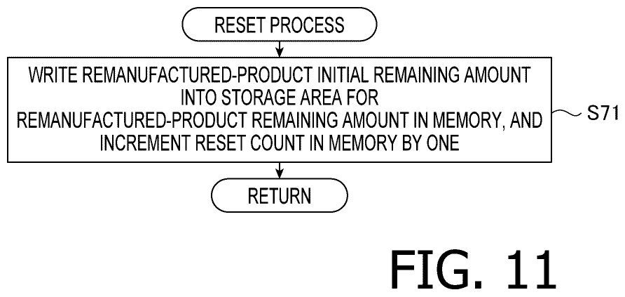

The new-product initial remaining amount 121 represents, for instance, an initial amount of the first ink 101A remaining in a new-product cartridge 100. The new-product initial remaining amount 121 is used as an initial value for the cartridge 100 that is sold commercially or bundled with the printer 10. The remanufactured-product initial remaining amount 122 represents, for instance, an initial amount of the first ink 101A remaining in a remanufactured-product cartridge 100 that has been remanufactured by the remanufacturer. The remanufactured-product initial remaining amount 122 is used as an initial value for the remanufactured product after the reset process (see FIG. 11) described below.

The new-product remaining amount 123 is a value indicating the remaining amount of the first ink 101A in the new-product cartridge 100, and decreases as the first ink 101A therein is used. The remanufactured-product remaining amount 124 is a value indicating the remaining amount of the first ink 101A in the remanufactured-product cartridge 100, and decreases as the first ink 101A therein is used.

The cartridge type information 125 is information indicating the type of the cartridge 100. Specifically, the cartridge type information 125 includes information indicating whether the cartridge 100 is a commercially sold cartridge or a cartridge bundled with the printer 10. The cartridge type information 125 further includes information indicating the color of the ink 101 in the cartridge 100. The signature information 126 is used for the authentication of the cartridge 100 and represents a hash value used in the authentication process described later. It is noted that the signature information 126 may be encrypted. The reset count 127 indicates the number of times the cartridge 100 has been remanufactured. For instance, the reset count 127 is initially set to zero and is incremented by one each time the remanufacturing (i.e., the reset process in FIG. 11) of the cartridge 100 is performed. The ID information 128 is information for identifying the cartridge 100 (more specifically, the IC board 105). For instance, a unique value (such as a number or a combination of characters) is assigned to each cartridge 100.

The new-product equilibrium calculation parameter 129 is a parameter used to calculate, with respect to the new-product cartridge 100, the amount of the first ink 101A in the liquid chamber 103A and the amount of the second ink 101B in the sub-tank 37, based on the new-product remaining amount 123. The remanufactured-product equilibrium calculation parameter 130 is a parameter used to calculate, with respect to the remanufactured-product cartridge 100, the amount of the first ink 101A in the liquid chamber 103A and the amount of the second ink 101B in the sub-tank 37, based on the remanufactured-product remaining amount 124. The new-product initial remaining amount 121, the remanufactured-product initial remaining amount 122, the cartridge type information 125, the signature information 126, the ID information 128, the new-product equilibrium calculation parameter 129, and the remanufactured-product equilibrium calculation parameter 130 are, for instance, fixed values set at the time of manufacturing by the manufacturer. These values are not changed by access from the controller 30 or before and after the remanufacturing of the cartridge 100. These values are stored, for instance, in a memory area where the information is not overwritten (i.e., remains unchanged) by the controller 30.

FIG. 5 illustrates examples of the two equilibrium calculation parameters and the states of the ink 101 in the cartridge 100 and the sub-tank 37. Suppose, for instance, that a new-product cartridge 100 is installed in the storage compartment 41 while the sub-tank 37 is empty. In this case, the liquid chamber 103A and the sub-tank 37 are open to the atmosphere through the air communication passages 104A and 37B, respectively. Consequently, as indicated by the arrows in FIG. 5, due to a difference in hydraulic head, the first ink 101A flows from the liquid chamber 103A of the cartridge 100 into the sub-tank 37 via the joint 39. An equilibrium state is reached when the levels of the liquid surface 131 of the first ink 101A in the liquid chamber 103A and the liquid surface 131 of the second ink 101B in the sub-tank 37 align at the same height in the vertical direction 1, as indicated by the dashed line in FIG. 5. That is, in the equilibrium state, the movement of the ink 101 between the liquid chamber 103A and the sub-tank 37 stops. Therefore, when the cartridge 100 is replaced, the ink 101 continues to move between the liquid chamber 103A and the sub-tank 37 until the levels of the liquid surface 131 of the ink 101 in the liquid chamber 103A and the liquid surface 131 of the ink 101 in the sub-tank 37 align at the same height in the vertical direction 1. In the equilibrium state, the relationship between the total amount of the ink 101 (i.e., the first ink 101A and the second ink 101B) and the amount of the ink 101 in each of the sub-tank 37 and the liquid chamber 103A may be approximated using a function derived from measured values.

The two graphs on the left side of FIG. 5 show approximate straight lines (i.e., approximate linear functions) derived from measured values for two cartridges 100 with different initial ink amounts. The horizontal axis of the graphs represents the total amount V of the ink 101 in milliliters [ml]. The vertical axis of the graphs represents the remaining amount Vs of the ink 101 stored in the sub-tank 37 in milliliters [ml]. In the illustrative embodiment, the liquid chamber 103A has a configuration where the lower portion, to which the joint 39 is connected, differs in size from the upper portion above the position where the joint 39 is connected. Specifically, with respect to the lengths of the liquid chamber 103A in the front-rear direction 3, the upper portion above the position where the joint 39 is connected is longer than the lower portion to which the joint 39 is connected. Accordingly, the relationship between the total amount V and the remaining amount Vs may be expressed using respective approximate linear functions F1 and F2 for the two portions of the liquid chamber 103A that differ in size. In other words, the functions F1 and F2 represent the relationships between the total amount V and the remaining amount Vs in the respective portions of the liquid chamber 103A.

The function F1 represents the relationship between the total amount V and the remaining amount Vs when the total amount V is equal to or greater than a threshold value Vh, and is expressed, for instance, as follows.

F1: Vs=a×V+b, where a and b are constants.

The function F2 represents the relationship between the total amount V and the remaining amount Vs when the total amount V is less than the threshold value Vh, and is expressed, for instance, as follows.

F2: Vs=c×V+d, where c and d are constants.

The threshold value Vh corresponds to the total amount V when the liquid surface 131 of the first ink 101A in the liquid chamber 103A reaches the upper end of a connection portion of the joint 39.

The controller 30 calculates the remaining amount Vs of the ink 101 in the sub-tank 37 and the remaining amount Vc of the ink 101 in the liquid chamber 103A using the two functions F1 and F2. For instance, when the total amount V is equal to or greater than the threshold value Vh, that is, when the liquid surface 131 of the first ink 101A is at or above the upper end of the connection portion of the joint 39, the controller 30 calculates the remaining amount Vs using the function F1. Conversely, when the total amount Vis less than the threshold value Vh, that is, when the liquid surface 131 of the first ink 101A is below the upper end of the connection portion of the joint 39, the controller 30 calculates the remaining amount Vs using the function F2.

The two graphs in FIG. 5 illustrate examples of different equilibrium calculation parameters. The upper graph (Example 1) represents a case where the initial amount of the ink 101 stored in the cartridge 100 (i.e., the total amount of the first ink 101A before use) is 40 ml. The lower graph (Example 2) represents a case where the initial amount is 80 ml. For instance, in the case of the upper graph (Example 1), when the total amount V of the ink 101 is 30 ml, the remaining amount Vs of the second ink 101B in the sub-tank 37 is approximately 13 ml, and the remaining amount Vc of the ink 101 in the liquid chamber 103A of the cartridge 100 is approximately 17 ml. Further, in the case of the lower graph (Example 2), when the total amount V of the ink 101 is 30 ml, the remaining amount Vs of the second ink 101B in the sub-tank 37 is approximately 9 ml, and the remaining amount Vc of the ink 101 in the liquid chamber 103A of the cartridge 100 is approximately 21 ml.

The new-product equilibrium calculation parameter 129 and the remanufactured-product equilibrium calculation parameter 130 include, for instance, information for determining the slopes, the intercepts, and the threshold value Vh of the above-described functions F1 and F2. The slopes, the intercepts, and the threshold value Vh of each type of the functions F1 and F2 are stored in the ROM 44 of the printer 10. For instance, the ROM 44 stores five sets of information corresponding to five types (i.e., first to fifth types) of the functions F1 and F2. Each set includes slopes, intercepts, and a threshold value Vh corresponding to a specific type of the functions F1 and F2. As described above, the slopes, the intercepts, and the threshold value Vh of the functions F1 and F2 vary depending on the initial amount of the ink 101 stored in the cartridge 100. Accordingly, the five sets of information stored in the ROM 44 correspond to five different initial amounts.

Additionally, the memory 110 stores the new-product equilibrium calculation parameter 129, which corresponds to the new-product initial remaining amount 121, and the remanufactured-product equilibrium calculation parameter 130, which corresponds to the remanufactured-product initial remaining amount 122. The information in the new-product equilibrium calculation parameter 129 and the remanufactured-product equilibrium calculation parameter 130 indicates which type (e.g., which ordinal number) among the first to fifth types of the functions F1 and F2 stored in the ROM 44 is to be selected. Specifically, the number indicated by the new-product equilibrium calculation parameter 129 corresponds to the functions F1 and F2 associated with the new-product initial remaining amount 121. Further, the number indicated by the remanufactured-product equilibrium calculation parameter 130 corresponds to the functions F1 and F2 associated with the remanufactured-product initial remaining amount 122. For instance, when the installed cartridge 100 is a new product, and the new-product equilibrium calculation parameter 129 stored in the memory 110 indicates “2,” the controller 30 selects and uses the second type of the functions F1 and F2, as well as the threshold value Vh corresponding to “2,” among the five sets of information stored in the ROM 44, to calculate the remaining amount Vs of the ink 101 stored in the sub-tank 37 and the remaining amount Vc of the ink 101 in the liquid chamber 103A. Thus, the controller 30 is enabled to select an appropriate type of the functions F1 and F2 based on the initial ink amount of the installed cartridge 100.

It is noted that the aforementioned new-product equilibrium calculation parameter 129 and the aforementioned remanufactured-product equilibrium calculation parameter 130 are merely examples. For instance, the new-product equilibrium calculation parameter 129 and the remanufactured-product equilibrium calculation parameter 130 may include information that directly indicates the slopes, the intercepts, and the threshold value Vh of the functions F1 and F2. This configuration allows the printer 10 to obtain equilibrium calculation parameters that are not pre-stored in the printer 10 from the memory 110 of the cartridge 100 and to use the obtained equilibrium calculation parameters. Suppose, for instance, that a cartridge 100 is sold with a new initial ink amount that has not been available before. In this case, an equilibrium calculation parameter corresponding to the new initial ink amount may be stored in the memory 110 as the new-product equilibrium calculation parameter 129, thereby enabling the printer 10 to obtain and use the equilibrium calculation parameter.

In another instance, the new-product equilibrium calculation parameter 129 and the remanufactured-product equilibrium calculation parameter 130 may include a set of data that associates a plurality of measured values with the remaining amount Vs of the ink 101 stored in the sub-tank 37 for each initial ink amount of the cartridge 100. In this case, the controller 30 may select the data set corresponding to the specified initial ink amount of the cartridge 100, detect an actually measured total amount V of the ink 101 that is close to a calculated total amount V from the selected data set, and calculate the remaining amount Vc of the ink 101 in the liquid chamber 103A using the remaining amount Vs of the ink 101 in the sub-tank 37 that is associated with the detected total amount V. Additionally, depending on the shape of the liquid chamber 103A and/or the sub-tank 37, the number of functions may vary—for instance, it may be one, three, or more.

### Cartridge Processing

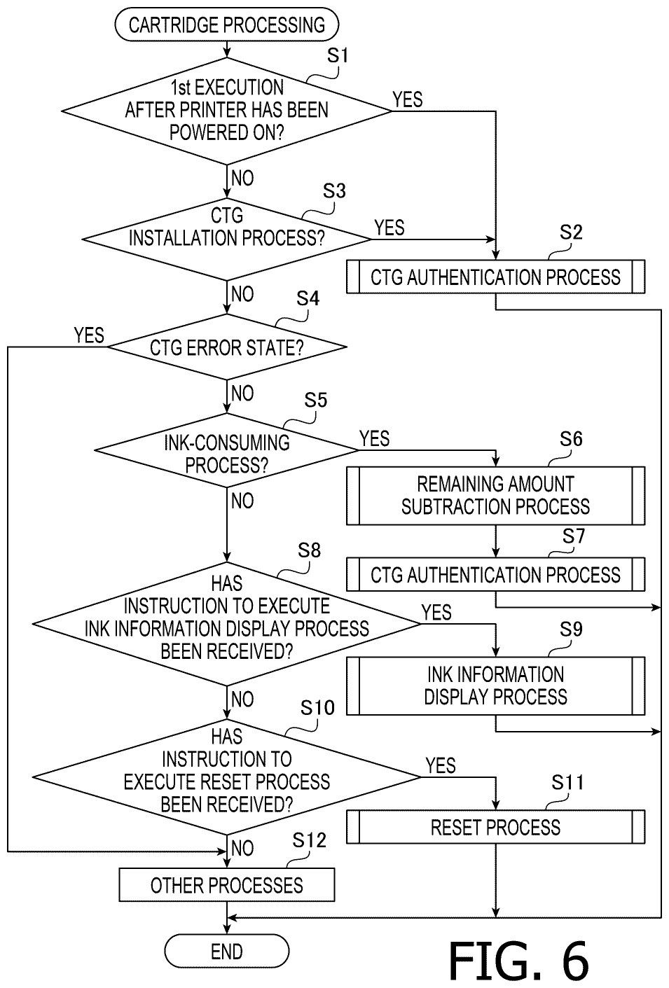

Next, cartridge processing to be executed by the controller 30 is described with reference to FIGS. 6 to 11. By executing this cartridge processing, the controller 30 performs authentication of the cartridge 100, determination of equilibrium calculation parameters, remaining amount calculation, remaining amount display, and a reset process. These processes are included as examples of “consumable processing” according to aspects of the present disclosure. For instance, after the printer 10 is powered on and the system is activated by the controller 30 executing control programs 44a stored in the ROM 44, the controller 30 starts the cartridge processing shown in FIG. 6. It is noted that feasible conditions for starting the cartridge processing shown in FIG. 6 are not limited to powering on the printer 10, but may also include conditions such as receiving a start instruction from the user or replacing the cartridge 100. Additionally, in the drawings from FIG. 6 onward, the term “cartridge” may be abbreviated as “CTG.”

In the following description, to avoid complexity, the processing is explained for one cartridge 100 among the four cartridges 100 that are attachable to the attachment case 27. However, when processing is performed for a plurality of cartridges 100, substantially the same processing as described below may be executed individually for each cartridge 100.

Upon starting the processing shown in FIG. 6, the controller 30 first determines in Step (hereinafter simply referred to as “S”) 1 whether S1 is being executed for the first time after the printer 10 has been powered on. In response to determining that S1 is being executed for the first time after the printer 10 has been powered on (S1: YES), the controller 30 performs a CTG authentication process in S2. After completing the processing shown in FIG. 6, the controller 30 executes the processing from SI again. Accordingly, in a state (hereinafter, which may be referred to as a “power-on state”) where the printer 10 remains powered on, the controller 30 repeatedly executes the cartridge processing shown in FIG. 6. When executing S1 for the second or subsequent time in the power-on state, the controller 30 makes a negative determination in S1 (S1: NO) and proceeds to execute S3.

In S3, the controller 30 determines whether a CTG installation process to install a cartridge 100 has been performed in the power-on state of the printer 10. In response to determining that the CTG installation process has been performed in the power-on state of the printer 10 (S3: YES)—for instance, when a cartridge 100 is installed in the empty attachment case 27 for the first time (S3: YES) or when an already installed cartridge 100 is replaced (S3: YES)—the controller 30 executes S2. In response to determining that the CTG installation process has not been performed in the power-on state of the printer 10 (S3: NO)—for instance, when no cartridge installation or replacement is performed (S3: NO)—the controller 30 executes S4.

### CTG Authentication Process

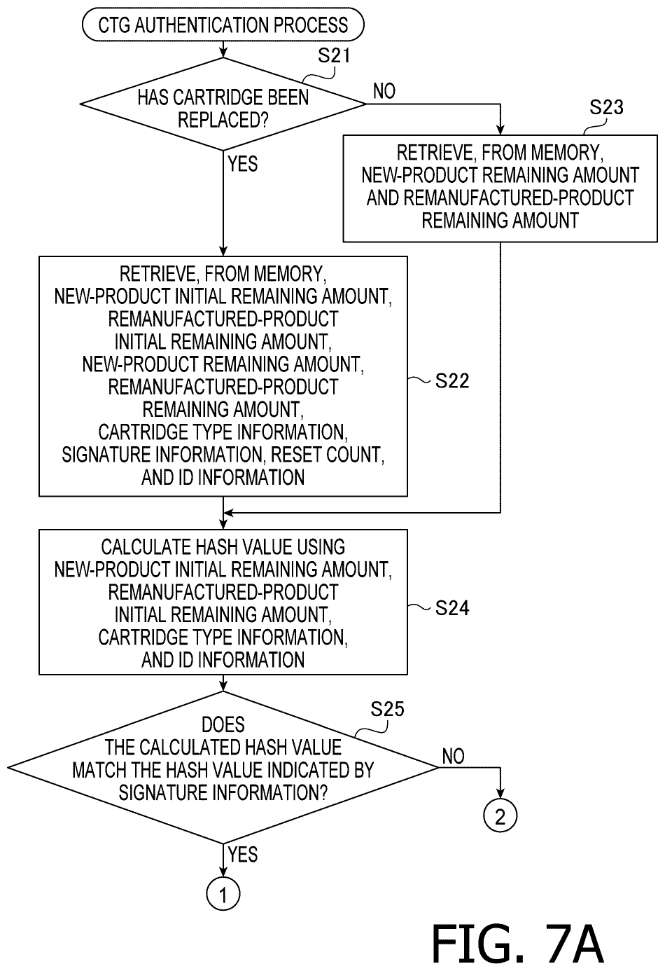

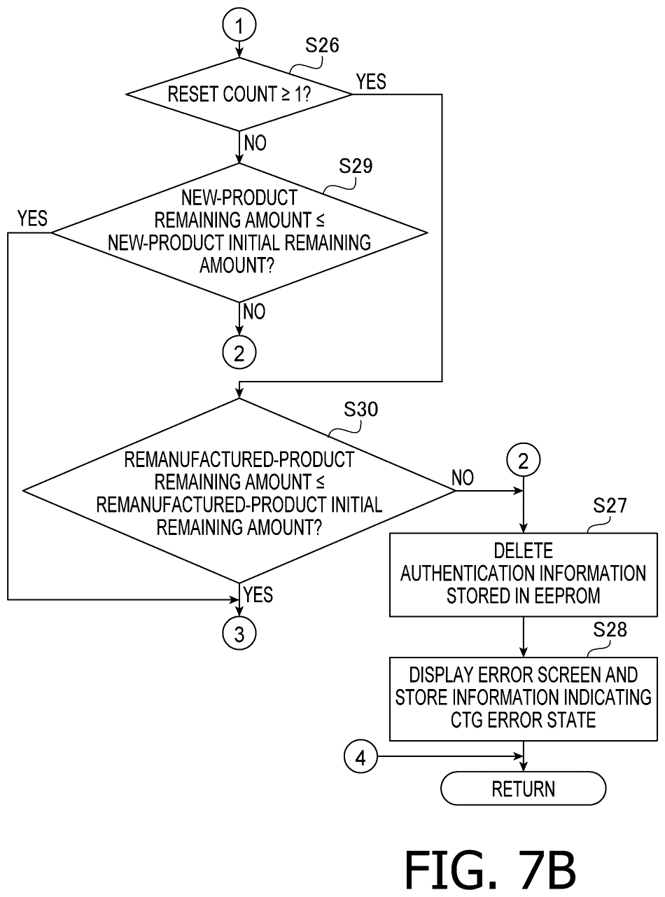

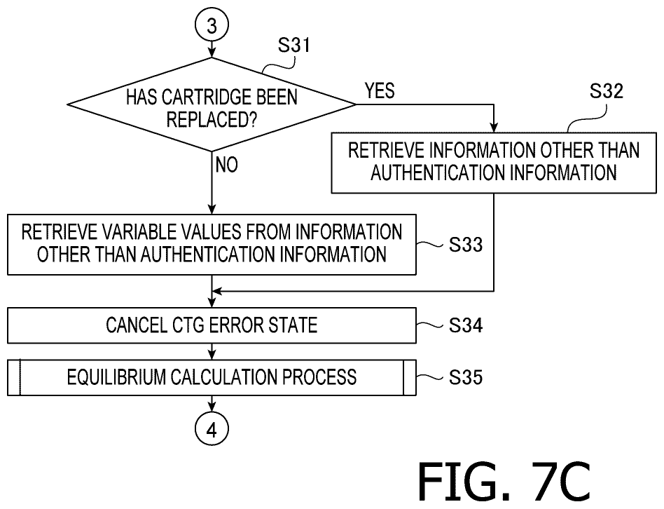

As shown in FIG. 7A, upon starting the CTG authentication process, the controller 30 first determines whether the cartridge 100 has been replaced (S21). For instance, the controller 30 makes this determination in S21 based on whether the ID information 128 and the reset count 127 already stored in the EEPROM 46 match the ID information 128 and the reset count 127 retrieved from the currently installed cartridge 100. In S22, which is described later, the controller 30 retrieves the ID information 128 and the reset count 127 from the memory 110 and stores them in the EEPROM 46. In S21, the controller 30 compares the ID information 128 and the reset count 127 already stored in the EEPROM 46—namely, the ID information 128 and the reset count 127 that were retrieved from the memory 110 of the cartridge 100 and stored in the EEPROM 46 during the previous execution of S22—with the ID information 128 and the reset count 127 retrieved from the memory 110 of the cartridge 100 installed at the present time (i.e., at the time of executing S21). If the ID information 128 already stored in the EEPROM 46 matches the ID information 128 retrieved from the currently installed cartridge 100 and the reset count 127 already stored in the EEPROM 46 matches the reset count 127 retrieved from the currently installed cartridge 100, the controller 30 makes a negative determination in S21, meaning that the cartridge 100 has not been replaced (S21: NO). Thereafter, the controller 30 proceeds to execute S23. Accordingly, if the printer 10 is powered off and then powered on again without replacement of the cartridge 100 (S1: YES), the controller 30 makes a negative determination in S21. Furthermore, if the same cartridge 100 is removed and reinstalled while the printer 10 remains in the power-on state (S3: YES), the controller 30 also makes a negative determination in S21.

In S21, when at least one of the ID information 128 or the reset count 127 already stored in the EEPROM 46 does not match the corresponding one of the ID information 128 or the reset count 127 retrieved from the currently installed cartridge 100, the controller 30 determines that the cartridge 100 has been replaced (S21: YES). Thereafter, the controller 30 proceeds to execute S22. Accordingly, when the cartridge 100 is replaced with a different cartridge 100, the controller 30 makes an affirmative determination in S21. Additionally, even if the same cartridge 100 is used, the controller 30 makes an affirmative determination in S21 when the cartridge 100 has undergone remanufacturing and the reset count 127 has been incremented. It is noted that the controller 30 may make the determination in S21 based on only one of the ID information 128 or the reset count 127.

In S22, the controller 30 retrieves the new-product initial remaining amount 121, the remanufactured-product initial remaining amount 122, the new-product remaining amount 123, the remanufactured-product remaining amount 124, the cartridge type information 125, the signature information 126, the reset count 127, and the ID information 128 from the memory 110 of the cartridge 100. The controller 30 then stores the retrieved information in the EEPROM 46. These eight pieces of information are used for authentication of the cartridge 100. Hereinafter, they may collectively be referred to as “authentication information.” Feasible storage destinations for the authentication information are not limited to the EEPROM 46 and may include the ROM 44. Additionally, in S23, the controller 30 retrieves only the new-product remaining amount 123 and the remanufactured-product remaining amount 124 from the authentication information in the memory 110 and stores them in the EEPROM 46.

As described above, the new-product initial remaining amount 121, the remanufactured-product initial remaining amount 122, the cartridge type information 125, the signature information 126, and the ID information 128 are fixed values that remain unchanged even when the cartridge 100 undergoes remanufacturing or other processes. Accordingly, when the controller 30 determines in S21 that the cartridge 100 has not been replaced, these fixed values do not need to be retrieved. This is because the authentication information stored in the memory 110 and the authentication information stored in the EEPROM 46 are identical. Therefore, in S23, the controller 30 retrieves only the new-product remaining amount 123 and the remanufactured-product remaining amount 124, which are variable values. This reduces the processing load and the processing time required for obtaining the authentication information. Additionally, reducing the number of retrieval operations from the memory 110 helps suppress the degradation of the cartridge 100. The controller 30 then executes the processes described below in S24 to S30 using the authentication information stored in the EEPROM 46. It is noted that, in another instance, the controller 30 may retrieve necessary authentication information from the memory 110 each time it executes an individual step.

After executing S22 or S23, the controller 30 proceeds to execute S24. In S24, the controller 30 calculates a hash value for authentication. For instance, the controller 30 calculates the hash value using a particular arithmetic formula, the new-product initial remaining amount 121, the remanufactured-product initial remaining amount 122, the cartridge type information 125, and the ID information 128. Specifically, for instance, the controller 30 may calculate the hash value using the sum and/or the product of the new-product initial remaining amount 121 and the remanufactured-product initial remaining amount 122. It is noted that feasible methods for calculating the hash value are not limited to the aforementioned approach, but may also include other methods—e.g., using only the sum of the new-product initial remaining amount 121 and the remanufactured-product initial remaining amount 122, using only the product of the new-product initial remaining amount 121 and the remanufactured-product initial remaining amount 122, or using the quotient obtained by dividing the new-product initial remaining amount 121 by the remanufactured-product initial remaining amount 122. Furthermore, the controller 30 may use information stored in the memory 110 and/or the printer 10, either instead of or in addition to the aforementioned information, to calculate the hash value. Additionally, the hash value calculation may be executed by the cartridge 100 (e.g., the control section 112 of the IC board 105), instead of the controller 30.

After calculating the hash value in S24, the controller 30 compares the calculated hash value with the hash value indicated by the signature information 126 stored in the EEPROM 46 (S25). Accordingly, at the time of manufacturing the cartridge 100, the memory 110 may store, as the signature information 126, a hash value calculated using the particular arithmetic formula and the four values (including the cartridge type information 125) as described in S24. Thus, if an unauthorized entity modifies information-such as the remanufactured-product initial remaining amount 122-without the manufacturer's approval, the printer 10 is enabled to detect such unauthorized modifications or tampering by comparing the hash values.

Feasible methods for authenticating the cartridge 100 are not limited to the aforementioned method but may also include other approaches. For instance, the controller 30 may perform authentication using a plurality of hash values. Specifically, the controller 30 may individually calculate hash values for the new-product initial remaining amount 121, the remanufactured-product initial remaining amount 122, the cartridge type information 125, the signature information 126, the reset count 127, and the ID information 128. The controller 30 may then determine whether each calculated hash value matches the corresponding hash value stored in the memory 110. In this case, the controller 30 may make an affirmative determination in S25 only if all the calculated hash values match their corresponding hash values stored in the memory 110.

In another instance, the signature information 126 may include electronic signature information, such as an encrypted electronic document. For instance, the memory 110 may store the signature information 126 as an electronic document encrypted using a private key known only to the manufacturer. Additionally, a public key may be stored in the ROM 44 of each printer 10. In S25, the controller 30 may determine that authentication has succeeded (S25: YES) in at least one of the following cases—when the signature information 126 is successfully decrypted using the public key or when the decrypted electronic document contains valid data. Furthermore, in S25, the controller 30 may send the signature information 126 and the ID information 128 from the memory 110 to an authentication server to authenticate the cartridge 100. Accordingly, authentication in S25 may employ known authentication methods, such as those used for electronic signatures.

In response to determining that the calculated hash value matches the hash value indicated by the signature information 126 stored in the EEPROM 46—i.e., that authentication has succeeded (S25: YES)—the controller 30 proceeds to execute S26. Conversely, in response to determining that the calculated hash value does not match the hash value indicated by the signature information 126 stored in the EEPROM 46—i.e., that authentication has failed (S25: NO)—the controller 30 deletes the authentication information retrieved from the memory 110 and stored in the EEPROM 46 (S27). This allows the printer 10 to remove the information associated with a cartridge 100 that has failed authentication.

After executing S27, the controller 30 displays an error screen on the touch panel 48, indicating that authentication of the cartridge 100 has failed (S28). Additionally, the controller 30 stores information indicating that an error has occurred with the cartridge 100 (hereinafter referred to as a “CTG error state”) (S28). For instance, the controller 30 may store a flag value in the RAM 45 to indicate that the CTG error state has occurred. This flag value is referenced in S4 of FIG. 6, where the controller 30 makes a positive determination (S4: YES). The process in S4 of FIG. 6 will be described later. The controller 30 then terminates the CTG authentication process (i.e., S2 of FIG. 6) shown in FIGS. 7A to 7C and restarts the cartridge processing (see FIG. 6) from S1. Additionally, the controller 30 may write information indicating the occurrence of the CTG error state into the memory 110.

Meanwhile, in S26, the controller 30 determines whether or not the reset count 127 is equal to or greater than one. As described above, the reset count 127 indicates the number of times the cartridge 100 has been remanufactured. A value of “0” is set for a new-product cartridge. If the reset count 127 is equal to or greater than one, it indicates that the cartridge 100 is a remanufactured product. In response to determining that the reset count 127 is less than one (S26: NO)—meaning that the cartridge 100 is a new-product cartridge-the controller 30 proceeds to S29 to determine whether or not the new-product remaining amount 123 is equal to or less than the new-product initial remaining amount 121. If the new-product remaining amount 123 is greater than the new-product initial remaining amount 121, it means that the stored new-product remaining amount 123 exceeds the maximum amount allowed by the manufacturer for a new-product cartridge 100. This may indicate a possibility of unauthorized modification or data corruption of the new-product remaining amount 123. Additionally, since the new-product remaining amount 123 and the remanufactured-product remaining amount 124 are not used for authentication in S24 and S25, it is necessary to verify whether they contain appropriate values. Accordingly, if the new-product remaining amount 123 is greater than the new-product initial remaining amount 121 (S29: NO), the controller 30 executes S27 and S28, performing substantially the same processing as in the case of an authentication error.

Additionally, in response to determining that the reset count 127 is equal to or greater than one (S26: YES)—meaning that the cartridge 100 is a remanufactured product—the controller 30 proceeds to S30. In S30, in substantially the same manner as in S29, the controller 30 determines whether or not the remanufactured-product remaining amount 124 is equal to or less than the remanufactured-product initial remaining amount 122. If the remanufactured-product remaining amount 124 is greater than the remanufactured-product initial remaining amount 122, it suggests that an unauthorized remanufactured-product remaining amount 124 has been set, in substantially the same manner as described above. Accordingly, in response to determining that the remanufactured-product remaining amount 124 is greater than the remanufactured-product initial remaining amount 122 (S30: NO), the controller 30 executes S27 and S28, performing substantially the same processing as in the case of an authentication error.

Furthermore, in response to making an affirmative determination in S29 (S29: YES) or S30 (S30: YES)—meaning that the new-product remaining amount 123 is equal to or less than the new-product initial remaining amount 121, or that the remanufactured-product remaining amount 124 is equal to or less than the remanufactured-product initial remaining amount 122, and that the CTG error state has not occurred—the controller 30 proceeds to S31 and subsequent steps to retrieve information from the memory 110. In substantially the same manner as in S21, the controller 30 determines in S31 whether the cartridge 100 has been replaced. In response to determining that the cartridge 100 has been replaced (S31: YES), the controller 30 retrieves information other than the authentication information from the memory 110 and stores the retrieved information in the EEPROM 46 (S32). Since the authentication information has already been retrieved into the EEPROM 46 in S22 or S23, the controller 30 retrieves information other than authentication information in S32. Specifically, such information to be retrieved includes, for instance, the new-product equilibrium calculation parameter 129, the remanufactured-product equilibrium calculation parameter 130, and other information stored in the memory 110.

In response to determining that the cartridge 100 has not been replaced (S31: NO), the controller 30 retrieves variable values from among information other than the authentication information in the memory 110 (S33). If the cartridge 100 has not been replaced, the fixed values (e.g., the new-product equilibrium calculation parameter 129 and the remanufactured-product equilibrium calculation parameter 130) that remain unchanged after being stored in the memory 110 were already retrieved and stored in the EEPROM 46 in S32 during the previous execution of the cartridge processing shown in FIG. 6. Accordingly, in S33, the controller 30 retrieves only variable values, such as flag values stored in the memory 110, rather than the fixed values.

After executing either S32 or S33, the controller 30 proceeds to execute S34. The controller 30 has successfully completed the cartridge authentication (S25), the remaining ink amount verification (S29 or S30), and the information retrieval (S32 or S33). Therefore, the controller 30 cancels the CTG error state if the CTG error state has occurred (S34). This allows the CTG error state to be canceled if a different cartridge 100 is installed and successfully authenticated after the CTG error state has occurred. After executing S34, the controller 30 proceeds to execute an equilibrium calculation process in S35.

### Equilibrium Calculation Process

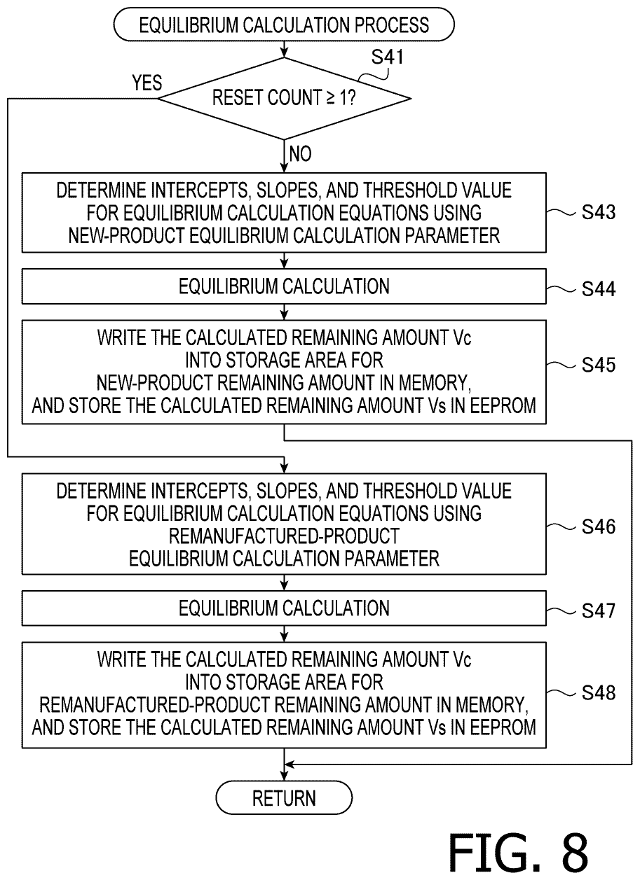

The controller 30 executes S35 using the information retrieved from the memory 110 and stored into the EEPROM 46 during the process shown in FIGS. 7A to 7C. As shown in FIG. 8, upon starting the equilibrium calculation process, the controller 30 first determines whether or not the reset count 127 is equal to or greater than one (S41). In response to determining that the reset count 127 is less than one (S41: NO)—meaning that the cartridge 100 is a new-product cartridge—the controller 30 determines the intercepts, the slopes, and the threshold value Vh for the equilibrium calculation equations using the new-product equilibrium calculation parameter 129 (S43). Specifically, as described above, the controller 30 selects the intercept, the slope, and the threshold value Vh corresponding to the number indicated by the new-product equilibrium calculation parameter 129 from among the plurality of sets of information stored in the ROM 44 that correspond to the plurality of types of the functions F1 and F2, each set including the slopes, the intercepts, and the threshold value Vh corresponding to the functions F1 and F2. The controller 30 then determines these selected values as values used for the equilibrium calculation.

The controller 30 performs the equilibrium calculation using the values (i.e., the intercepts, the slopes, and the threshold value Vh) determined in S43 (S44). For instance, the controller 30 calculates the total amount V of the ink 101 based on the remaining amount Vs and the new-product remaining amount 123 stored in the EEPROM 46. Specifically, the controller 30 adds the latest remaining amount Vs of the ink 101 in the sub-tank 37, which is stored in the EEPROM 46, to the new-product remaining amount 123 retrieved from the memory 110 of the installed cartridge 100, thereby calculating the total amount V. The controller 30 compares the calculated total amount V with the threshold value Vh shown in FIG. 5. The controller 30 then determines which function (defined by the specific slope and the specific intercept) is to be used for the equilibrium calculation among the two functions F1 and F2 determined in S43. If the total amount V is equal to or greater than the threshold value Vh, the controller 30 uses the intercept and the slope of the function F1. If the total amount Vis less than the threshold value Vh, the controller 30 uses the intercept and the slope of the function F2. The controller 30 substitutes the total amount V into the selected function and calculates the remaining amount Vs of the ink 101 in the sub-tank 37. The controller 30 then subtracts the calculated remaining amount Vs from the total amount V to calculate the remaining amount Vc of the ink 101 in the cartridge 100 (S44).

The controller 30 writes the remaining amount Vc calculated in S44 into a storage area for the remaining amount Vc (i.e., a storage area for the new-product remaining amount 123) in the memory 110 (S45). Additionally, the controller 30 stores the remaining amount Vs calculated in S44 in a storage area for the remaining amount Vs in the EEPROM 46 (S45). Namely, the controller 30 updates the information on the remaining amounts Vs and Vc. Thus, by executing the equilibrium calculation process when the printer 10 is powered on or after replacement of the cartridge 100, the controller 30 is enabled to update the information on the remaining ink amounts in the cartridge 100 and the sub-tank 37. Furthermore, the controller 30 manages the remaining amount Vc of the first ink 101A in the cartridge 100 using the memory 110 of the cartridge 100. Meanwhile, the controller 30 manages the remaining amount Vs of the second ink 101B in the sub-tank 37 using the EEPROM 46 of the printer 10. After executing S45, the controller 30 terminates the process shown in FIG. 8, as well as the processing shown in FIGS. 7A to 7C and 6. The controller 30 then restarts the processing from S1.

Additionally, in response to determining in S41 of FIG. 8 that the reset count 127 is equal to or greater than one (S41: YES)—meaning that the cartridge 100 is a remanufactured product-the controller 30 determines the intercepts, the slopes, and the threshold value Vh of the equilibrium calculation equations using the remanufactured-product equilibrium calculation parameter 130 (S46). The controller 30 performs the equilibrium calculation for the remanufactured product in substantially the same manner as in the case of the new-product cartridge (see S43 to S45). Accordingly, a detailed description of the equilibrium calculation for remanufactured products is omitted. The controller 30 performs the equilibrium calculation using the intercepts, the slopes, and the threshold value Vh determined in S46 (S47). The controller 30 then stores the calculated remaining amount Vs in the EEPROM 46 while writing the calculated remaining amount Vc into a storage area for the remaining amount Vc (i.e., a storage area for the remanufactured-product remaining amount 124) in the memory 110 (S48).

Thus, the controller 30 is enabled to determine the intercepts, the slopes, and the threshold value Vh for the equilibrium calculation based on the equilibrium calculation parameters stored in the memory 110. When a cartridge 100 with a new ink capacity is sold as a new product, or an allowable remaining amount for remanufactured products is modified, these changes may be accommodated by updating the equilibrium calculation parameters stored in the memory 110 of the cartridge 100. As a result, there is no need to update the information stored in the printer 10, eliminating the need for firmware updates. Furthermore, different parameters may be set in the memory 110 for new-product cartridges and remanufactured-product cartridges. Accordingly, the ink amounts for new-product and remanufactured-product cartridges may be set and managed separately.

In S4 of FIG. 6, the controller 30 determines whether the CTG error state has occurred. As described above, in the process shown in FIGS. 7A to 7C, the CTG error state occurs when authentication has failed (S25: NO), when the new-product remaining amount 123 is greater than the new-product initial remaining amount 121 (S29: NO), or when the remanufactured-product remaining amount 124 is greater than the remanufactured-product initial remaining amount 122 (S30: NO) (S28). If the flag value indicating the CTG error state has occurred is stored in the RAM 45 (S4: YES), the controller 30 proceeds to execute S12. When the controller 30 has made an affirmative determination in S4 (S4: YES)—meaning that an error has occurred with the cartridge 100—it is difficult for the controller 30 to execute an ink-consuming process such as printing. Accordingly, in S12, the controller 30 maintains the error screen on the touch panel 48 as displayed in S28 without executing the printing process. The controller 30 then terminates the processing shown in FIG. 6.

In response to determining that the CTG error state has not occurred (S4: NO), the controller 30 determines whether an ink-consuming process has been executed (S5). The ink-consuming process refers to a process that consumes the ink 101, including, for instance, a copy process, a printing process based on a print command from a PC, or a maintenance process such as cleaning. If the controller 30 determines that an ink-consuming process has been executed for the first time after the printer 10 was turned on (S5: YES), or that a new ink-consuming process has been executed after the previous execution of S5 (S5: YES), the controller 30 proceeds to S6 to execute a remaining amount subtraction process.

### Remaining Amount Subtraction Process

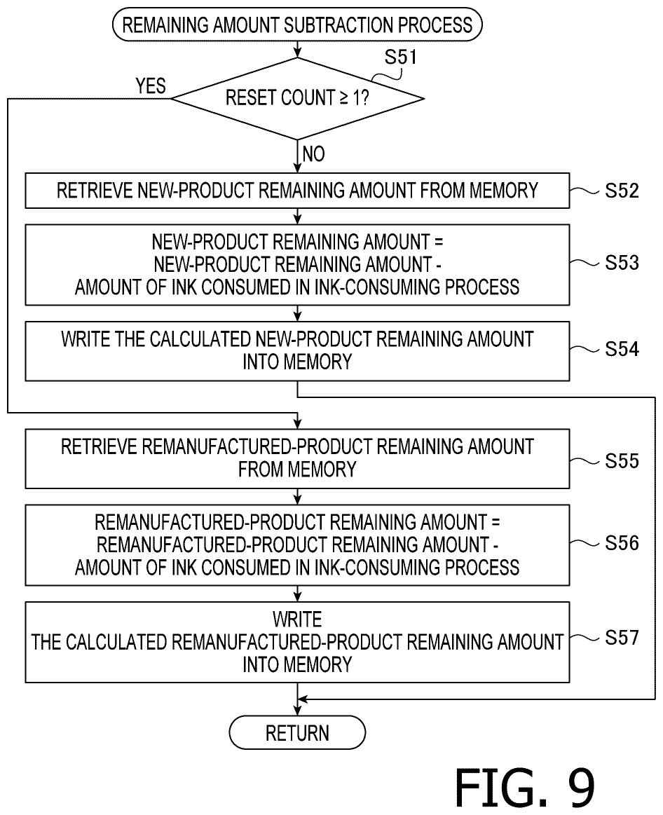

If the remaining amount subtraction process in S6 of FIG. 6 is executed, it indicates that an ink-consuming process has been performed and that the ink 101 has been consumed (S5: YES). By executing the remaining amount subtraction process shown in FIG. 9, the controller 30 updates the information in the memory 110 to reflect the remaining amount of the ink 101 after consumption. Accordingly, each time a new ink-consuming process is executed while the printer 10 is powered on, the controller 30 makes an affirmative determination in S5 (S5: YES) and updates the remaining amount of the ink 101 in S6.

As shown in FIG. 9, upon starting the remaining amount subtraction process, the controller 30 determines whether or not the reset count 127 is equal to or greater than one (S51). In response to determining that the reset count 127 is less than one (S51: NO)—indicating that the cartridge 100 is a new-product cartridge—the controller 30 retrieves the new-product remaining amount 123 from the memory 110 (S52). As described above, the controller 30 manages the latest remaining amount Vc (i.e., the new-product remaining amount 123 or the remanufactured-product remaining amount 124) by storing the latest remaining amount Vc in the memory 110 of the cartridge 100. Accordingly, the controller 30 retrieves the new-product remaining amount 123 from the memory 110 (S52) and subtracts the amount of ink 101 consumed in the ink-consuming process from the retrieved new-product remaining amount 123 (S53). More specifically, in S53, the controller 30 subtracts, from the new-product remaining amount 123 retrieved from the memory 110, the amount of ink 101 consumed in the ink-consuming process executed when an affirmative determination has been made in S5 of FIG. 6. Feasible methods for calculating the ink consumption amount (i.e., the amount of ink 101 consumed in the ink-consuming process) may include known methods. For instance, in the case of a copy process, the ink consumption amount may be calculated based on the number of printed pages and the number of ink dots ejected per page. After performing the subtraction in S53, the controller 30 stores the updated new-product remaining amount 123 in the memory 110 (S54). The controller 30 then terminates the process shown in FIG. 9. Thus, each time an ink-consuming process is executed, the controller 30 updates the new-product remaining amount 123 by subtracting the amount of ink 101 consumed in the ink-consuming process. This enables the total amount V of the ink 101 to be adjusted to accurately reflect ink consumption.

If the cartridge 100 is a remanufactured product (S51: YES), the controller 30 retrieves the remanufactured-product remaining amount 124 from the memory 110 (S55). The controller 30 then subtracts the amount of ink 101 consumed in the ink-consuming process from the retrieved remanufactured-product remaining amount 124 (S56) and stores the updated value in the memory 110 (S57). The process of subtracting the ink consumption amount from the retrieved remanufactured-product remaining amount 124 is substantially the same as the process described in S52 to S54 for the new-product remaining amount 123. Accordingly, a detailed description of this process is omitted.

As shown in FIG. 6, after executing the remaining amount subtraction process in S6, the controller 30 executes a CTG authentication process in S7, in substantially the same manner as in S2 (see FIGS. 7A to 7C). Accordingly, subsequent processing—including the equilibrium calculation process (S35)—is performed using the updated new-product remaining amount 123 or the updated remanufactured-product remaining amount 124 obtained in S6. Thus, the controller 30 is enabled to update the remaining amount Vc (i.e., the new-product remaining amount 123 or the remanufactured-product remaining amount 124) of the ink 101 in the liquid chamber 103A of the cartridge 100, as well as the remaining amount Vs of the ink 101 in the sub-tank 37, to reflect the total amount V of the ink 101 consumed in the ink-consuming process. After executing S7, the controller 30 terminates the processing shown in FIG. 6.

Meanwhile, in response to determining that an ink-consuming process has not been executed (S5: NO), the controller 30 determines whether an instruction to execute an ink information display process has been received (S8). For instance, the controller 30 may receive an instruction to execute the ink information display process based on a particular operation input via the touch panel 48 or the operation button 49. In response to determining that an instruction to execute the ink information display process has been received for the first time after the printer 10 was powered on (S8: YES), or that a new instruction to execute the ink information display process has been received after the previous execution of S8 (S8: YES), the controller 30 proceeds to S9 to execute the ink information display process. Conversely, in response to determining that an instruction to execute the ink information display process has not been received (S8: NO), the controller 30 proceeds to execute S10. Accordingly, each time the controller 30 receives an instruction to execute the ink information display process while the printer 10 is powered on, the controller 30 makes an affirmative determination in S8 (S8: YES) and proceeds to execute S9.

### Ink Information Display Process

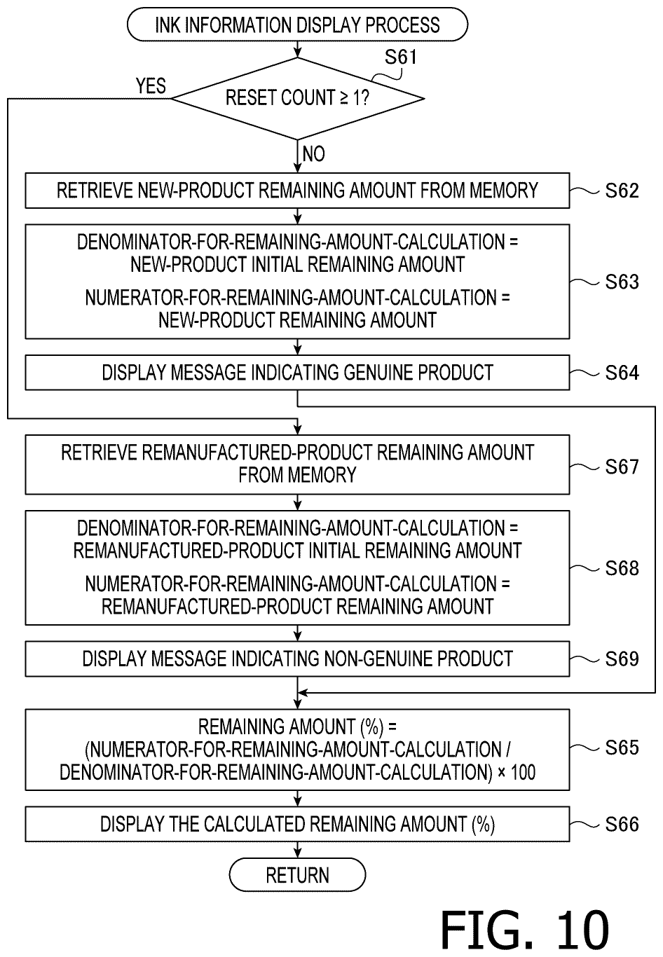

By executing the ink information display process shown in FIG. 10, the controller 30 displays the percentage of the remaining amount Vc (i.e., the new-product remaining amount 123 or the remanufactured-product remaining amount 124) relative to its initial value. As shown in FIG. 10, upon starting the ink information display process, the controller 30 determines whether or not the reset count 127 is equal to or greater than one (S61). In response to determining that the reset count 127 is less than one (S61: NO)—indicating that the cartridge 100 is a new-product cartridge—the controller 30 retrieves the new-product remaining amount 123 from the memory 110 (S62) and sets values used for calculation of the remaining amount to be displayed (S63). Specifically, the controller 30 sets the new-product initial remaining amount 121 as a “denominator-for-remaining-amount-calculation” and the new-product remaining amount 123 retrieved in S62 as a “numerator-for-remaining-amount-calculation” (S63).

Next, the controller 30 displays a message on the touch panel 48 indicating that the installed cartridge 100 is a genuine product (S64), and then calculates the percentage of the remaining amount Vc (S65). This enables the user to recognize whether the cartridge 100 in use was sold by the manufacturer or by a third-party entity, such as the remanufacturer. The controller 30 calculates the percentage of the remaining amount Vc using the values set in S63 for the “denominator-for-remaining-amount-calculation” and the “numerator-for-remaining-amount-calculation” according to the following equation.

Remaining Amount (%)=(Numerator-for-Remaining-Amount-Calculation Denominator-for-Remaining-Amount-Calculation)×100

The controller 30 then displays the calculated remaining amount (%) on the touch panel 48 (S66). Afterward, the controller 30 terminates the process shown in FIG. 10 and subsequently terminates the processing shown in FIG. 6.

Additionally, in response to determining that the reset count 127 is equal to or greater than one (S61: YES)—indicating that the cartridge 100 is a remanufactured-product cartridge-the controller 30 executes substantially the same processing as in the case of a new-product cartridge (see S62 to S64). Although a detailed description of the processing for a remanufactured product is omitted, the controller 30 retrieves the remanufactured-product remaining amount 124 from the memory 110 (S67), and sets the remanufactured-product initial remaining amount 122 as the “denominator-for-remaining-amount-calculation” and the remanufactured-product remaining amount 124 as the numerator-for-remaining-amount-calculation” (S68). The controller 30 then displays a message indicating that the cartridge 100 is a non-genuine product (S69), and substitutes the values set in S68 into the above equation to calculate the remaining amount (%) for the remanufactured product (S65). Afterward, the controller 30 displays the calculated remaining amount (%) (S66). Thus, the controller 30 is enabled to display the percentage of the remaining amount Vc based on the initial values corresponding to either the new-product cartridge or the remanufactured-product cartridge.

It is noted that the aforementioned method for displaying the remaining amount is merely an example. Feasible methods for displaying the remaining amount are not limited to the above approach but may also include other methods. For instance, the controller 30 may display the actual value of the remaining amount Vc (i.e., the new-product remaining amount 123 or the remanufactured-product remaining amount 124) in milliliters [ml]. In another instance, the controller 30 may display the percentage of the total amount V (i.e., the sum of the remaining amount Vc and the remaining amount Vs) relative to its initial value. In yet another instance, the controller 30 may individually display the remaining amount Vc and the remaining amount Vs in milliliters [ml]. Additionally, in S69, instead of displaying characters indicating “non-genuine product,” the controller 30 may display characters indicating “remanufactured product.” Furthermore, feasible methods for notifying the user of the remaining amount are not limited to displaying it on the touch panel 48. The controller 30 may also use a printer driver on a PC connected via the network I/F 51 to display the remaining amount on the PC screen.

As shown in FIG. 6, the controller 30 determines in S10 whether an instruction to execute the reset process has been received. Specifically, for instance, in substantially the same manner as in S8, the controller 30 may receive an instruction to execute the reset process based on a particular operation input via the touch panel 48 or the operation button 49. For instance, when the remanufacturer wants to replenish ink 101 in a used cartridge 100 and sell it as a remanufactured product, the remanufacturer executes this reset process. In response to determining that an instruction to execute the reset process has been received for the first time after the printer 10 was powered on (S10: YES), or that a new instruction to execute the reset process has been received after the previous execution of S10 (S10: YES), the controller 30 proceeds to S11 to execute the reset process. Conversely, in response to determining that an instruction to execute the reset process has not been received (S10: NO), the controller 30 proceeds to execute S12. Accordingly, each time the controller 30 receives an instruction to execute the reset process while the printer 10 is powered on, the controller 30 makes an affirmative determination in S10 (S10: YES) and proceeds to execute S11.

### Reset Process

As shown in FIG. 11, upon starting the reset process, the controller 30 writes the remanufactured-product initial remaining amount 122 into the storage area for the remanufactured-product remaining amount 124 in the memory 110 (S71). This allows the remanufactured-product initial remaining amount 122 to be reset as an initial value of the remaining amount Vc of ink 101 in the liquid chamber 103A of the cartridge 100 when the cartridge 100 is sold as a remanufactured product. Accordingly, the manufacturer may set, as the remanufactured-product initial remaining amount 122, an allowable value for the remanufactured-product initial remaining amount 122, thereby setting the initial ink amount of the cartridge 100 when the cartridge 100 is remanufactured by the remanufacturer—i.e., the amount of ink 101 in the cartridge 100 when the cartridge 100 is sold as a remanufactured product. Additionally, a remanufacturer's operator may check the initial ink amount (i.e., the remanufactured-product initial remaining amount 122) of the remanufactured product, thereby refilling the cartridge 100 with an appropriate amount of ink 101. For instance, for a cartridge 100 included with the printer 10, the remanufacturer's operator may set, as the remanufactured-product initial remaining amount 122, an amount of ink storable in the cartridge 100 that is close to the ink amount of a commercially available cartridge 100.

In S71, the controller 30 increments both the reset count 127 stored in the EEPROM 46 and the reset count 127 stored in the memory 110 by one. Accordingly, each time the reset process is executed and the cartridge 100 is remanufactured, the reset count 127 increases by one. Thus, the reset count 127 allows the number of times the cartridge 100 has been remanufactured to be tracked. After executing S71, the controller 30 terminates the process shown in FIG. 11 and subsequently terminates the processing shown in FIG. 6.

### Other Processes in S12

As shown in FIG. 6, the controller 30 executes other processes in S12. For instance, the other processes in S12 may refer to processes executed while the printer 10 is powered on, excluding the CTG authentication process, the remaining amount subtraction process, the ink information display process, and the reset process. Specifically, the other processes may include, for instance, a copy process, a printing process based on a command from a PC, and a cleaning process. In another instance, the other processes may include a setting process for the printer 10 based on operations input via the touch panel 48. Additionally, the other processes may include parts of the aforementioned processes, such as the CTG authentication process. Thus, the other processes in S12 may encompass various operations executed by the printer 10 while it is powered on. After executing S12, the controller 30 terminates the processing shown in FIG. 6.

The aforementioned illustrative embodiment provides the following advantageous effects. The controller 30 of the printer 10 retrieves information such as the new-product initial remaining amount 121 and the remanufactured-product initial remaining amount 122 from the memory 110 of the cartridge 100 installed in the attachment case 27 (e.g., S22, S23). Based on the retrieved new-product initial remaining amount 121 and other data, the controller 30 executes various processes related to the ink 101 (e.g., S24, S25, S29, S30, S35, S43, S46, S53, S56, S63, S66, S68, S71).

Accordingly, the controller 30 retrieves information regarding the initial state of the ink 101, such as the new-product initial remaining amount 121, from the memory 110 of the cartridge 100 installed in the printer 10 and executes processing related to the ink 101. This enables the information regarding the initial state of the ink 101 to be managed within the memory 110 of the cartridge 100. When the lineup of cartridges 100 is modified or a new lineup is added after the printer 10 has been released, these changes may be reflected in the printer 10 by storing information regarding a new initial state in the memory 110. As a result, even if a request is made to add a new ink amount or modify existing ink amounts after the printer 10 has been released, such changes may be accommodated by using the information stored in the memory 110 of the cartridge 100, without updating the firmware of the printer 10. For instance, if only 40 ml cartridges 100 were initially sold but later an 80 ml cartridge 100 is to be introduced, this may be accommodated by storing the new-product initial remaining amount 121 and the new-product equilibrium calculation parameter 129 for the 80 ml cartridge 100 in the memory 110. This reduces the operational burden on the user when changing information related to the ink 101.

Additionally, the controller 30 executes S2 when at least one of the following conditions is satisfied—when the printer 10 is powered on (S1: YES) or when a cartridge 100 is installed in the attachment case 27 (S3: YES). Accordingly, when the printer 10 is powered on or a cartridge 100 is replaced, the controller 30 retrieves information regarding the initial state of the ink 101 and uses the information of the currently installed cartridge 100 to perform authentication of the cartridge 100 and determine the remaining amount Vc of the ink 101 in the liquid chamber 103A of the cartridge 100. This enables the controller 30 to determine whether the installed cartridge 100 is appropriate.

Furthermore, even if the condition in which a cartridge 100 is installed in the attachment case 27 (S3: YES) is satisfied, when the ID information 128 of the previously installed cartridge 100 matches the ID information 128 stored in the memory 110 of the currently installed cartridge 100 (S21: NO), the controller 30 does not retrieve, from the memory 110, the particular information—i.e., the new-product initial remaining amount 121, the remanufactured-product initial remaining amount 122, the cartridge type information 125, the signature information 126, the reset count 127, and the ID information 128—other than the new-product remaining amount 123 and the remanufactured-product remaining amount 124 (S23). Accordingly, when the same cartridge 100 is detached and reattached, repeated retrieval of the information regarding the initial state of the ink 101 is inhibited, thereby suppressing unnecessary processing.

Moreover, the memory 110 stores the reset count 127, which indicates the number of times the remanufactured-product remaining amount 124 has been reset. Even if the controller 30 makes an affirmative determination in S3 (S3: YES), when the ID information 128 of the previously installed cartridge 100 matches the ID information 128 of the currently installed cartridge 100, and when the reset count 127 of both cartridges also match (S21: NO), the controller 30 does not retrieve, from the memory 110, the particular information—i.e., the new-product initial remaining amount 121, the remanufactured-product initial remaining amount 122, the cartridge type information 125, the signature information 126, the reset count 127, and the ID information 128—other than the new-product remaining amount 123 and the remanufactured-product remaining amount 124 (S23). Conversely, when at least one of the ID information 128 or the reset count 127 of the previously installed cartridge 100 does not match the corresponding one in the currently installed cartridge 100, the controller 30 retrieves, from the memory 110, the particular information—i.e., the new-product initial remaining amount 121, the remanufactured-product initial remaining amount 122, the cartridge type information 125, the signature information 126, the reset count 127, and the ID information 128—as well as the new-product remaining amount 123 and the remanufactured-product remaining amount 124 (S22).

Accordingly, even if the same cartridge 100 is detached and reattached, when the reset counts 127 before and after reattachment are different (e.g., when the remaining amount Vc has been reset due to remanufacturing of the cartridge 100), the controller 30 retrieves, from the memory 110, the particular information—i.e., the new-product initial remaining amount 121, the remanufactured-product initial remaining amount 122, the cartridge type information 125, the signature information 126, the reset count 127, and the ID information 128—as well as the new-product remaining amount 123 and the remanufactured-product remaining amount 124, again. This enables the controller 30 to perform authentication of the cartridge 100 and determine the remaining amount Vc of the ink 101 in the liquid chamber 103A of the cartridge 100 based on the updated new-product initial remaining amount 121 or the updated remanufactured-product initial remaining amount 122 after remanufacturing. Additionally, by retrieving the reset count 127, it is possible to manage the reset count 127 on the printer 10 side. For instance, in the printer 10, the controller 30 is enabled to execute the process to increment the reset count 127 (see FIG. 11) when configuring the installed cartridge 100 as a remanufactured product.

Furthermore, the memory 110 stores the new-product initial remaining amount 121 and the remanufactured-product initial remaining amount 122, which indicate the initial amount of ink 101 contained in the cartridge 100. The controller 30 calculates the remaining amount Vc based on either the new-product initial remaining amount 121 or the remanufactured-product initial remaining amount 122 (S65) and displays the percentage of the remaining amount Vc relative to its initial value (S66). Thus, the controller 30 calculates the percentage of the remaining amount Vc of the ink 101 in the liquid chamber 103A of the cartridge 100 relative to its initial value using the new-product initial remaining amount 121 or the remanufactured-product initial remaining amount 122 stored in the memory 110. Additionally, by displaying the remaining amount Vc as a percentage thereof relative to its initial value, the controller 30 presents information on how much the ink 101 has been consumed in a manner that is easy for the user to understand.

The controller 30 executes authentication of the cartridge 100 based on the information stored in the memory 110, such as the new-product initial remaining amount 121, the remanufactured-product initial remaining amount 122, the cartridge type information 125, and the ID information 128 (S24, S25). If authentication succeeds (S25: YES), the controller 30 proceeds to execute processes such as S29, S30, and S35. Conversely, if authentication fails (S25: NO), the controller 30 does not execute these processes, including S29, S30, and S35. Accordingly, even if unauthorized information is stored as, for instance, the new-product initial remaining amount 121 or the remanufactured-product initial remaining amount 122, executing authentication of the cartridge 100 inhibits the use of such unauthorized information.

Additionally, the signature information 126 may include electronic signature information, such as an electronic document encrypted using a private key. The controller 30 may execute authentication of the cartridge 100 in S25 by decrypting the signature information 126 stored in the memory 110 using a public key stored in the ROM 44. Accordingly, by including the electronic signature information in the information stored in the memory 110, the controller 30 may execute authentication of the cartridge 100 using the electronic signature information. The use of the electronic signature information enables the controller 30 to determine whether the cartridge 100 is authentic.

In the aforementioned illustrative embodiment, the memory 110 stores a hash value for authentication as the signature information 126. In response to determining in S25 that the hash value calculated based on a specific arithmetic formula using the new-product initial remaining amount 121, the remanufactured-product initial remaining amount 122, the cartridge type information 125, and the ID information 128 matches the hash value indicated by the signature information 126 stored in the memory 110, the controller 30 determines that authentication has succeeded (S25: YES). Accordingly, the controller 30 may calculate a hash value based on the information stored in the memory 110 and perform authentication using the calculated hash value. The use of the hash value enables the controller 30 to determine whether the cartridge 100 is authentic.

Additionally, the memory 110 stores the reset count 127, which indicates whether the cartridge 100 has been remanufactured. The controller 30 performs different processes in FIGS. 7A to 7C, 8, 9, and 10 depending on whether or not the reset count 127 is equal to or greater than one-indicating whether the cartridge 100 is a remanufactured-product cartridge or a new-product cartridge. Accordingly, the controller 30 may modify the processing contents of the CTG authentication process (see FIGS. 7A to 7C), the equilibrium calculation process (see FIG. 8), the remaining amount subtraction process (see FIG. 9), and the ink information display process (see FIG. 10) based on whether the cartridge 100 is a remanufactured-product cartridge. Thus, the controller 30 is enabled to execute different processing depending on whether the cartridge 100 is a new-product cartridge or a remanufactured-product cartridge.

Additionally, the printer 10 includes a sub-tank 37 corresponding to each cartridge 100. Furthermore, the memory 110 stores a new-product equilibrium calculation parameter 129 and a remanufactured-product equilibrium calculation parameter 130. These parameters are used to calculate the amount of the first ink 101A in the liquid chamber 103A of each cartridge 100 and the amount of the second ink 101B in the corresponding sub-tank 37. The new-product equilibrium calculation parameter 129 is set to a value (i.e., a number from 1 to 5, indicating which type of the first to fifth types of the functions F1 and F2) corresponding to the new-product initial remaining amount 121, while the remanufactured-product equilibrium calculation parameter 130 is set to a value (i.e., a number from 1 to 5) corresponding to the remanufactured-product initial remaining amount 122. When the cartridge 100 is a new-product cartridge, the controller 30 calculates the remaining amount Vc of the ink 101 in the cartridge 100 based on the new-product equilibrium calculation parameter 129 and the corresponding information (e.g., the functions F1 and F2, and the threshold value Vh) (S44). When the cartridge 100 is a remanufactured-product cartridge, the controller 30 calculates the remaining amount Vc based on the remanufactured-product equilibrium calculation parameter 130 and the corresponding information (S47).

Thus, according to the aforementioned illustrative embodiment, the printer 10 includes a sub-tank 37 corresponding to each cartridge 100. Accordingly, even after the first ink 101A in a cartridge 100 is depleted, the printer 10 is enabled to continue printing using the second ink 101B stored in the corresponding sub-tank 37. Additionally, the amounts of ink storable in each cartridge 100 and its corresponding sub-tank 37 vary depending on the shape and the initial ink amount of the cartridge 100. Therefore, as described above, when a number representing the equilibrium calculation parameter for each cartridge 100 is stored in the memory 110 as the new-product equilibrium calculation parameter 129 or the remanufactured-product equilibrium calculation parameter 130, the controller 30 is enabled to accurately calculate the ink amounts in each cartridge 100 and its corresponding sub-tank 37.

Moreover, the memory 110 stores the new-product initial remaining amount 121 and the remanufactured-product initial remaining amount 122. The new-product initial remaining amount 121 indicates the initial remaining amount of the first ink 101A in a new-product cartridge 100 and is set during the manufacturing of the new-product cartridge 100. The remanufactured-product initial remaining amount 122 indicates the initial remaining amount of the first ink 101A in a remanufactured-product cartridge 100 and is used when the cartridge 100 is remanufactured. When resetting the remanufactured-product remaining amount 124 in order to remanufacture the cartridge 100, the controller 30 writes the remanufactured-product initial remaining amount 122 into the memory 110 as the remanufactured-product remaining amount 124 (S71). After the remanufactured product is installed in the attachment case 27, if the remanufactured-product remaining amount 124 exceeds the remanufactured-product initial remaining amount 122 retrieved from the memory 110 (S30: NO), the controller 30 skips the processing from S31 onward, including S35, in FIG. 7C.

Accordingly, the initial remaining ink amount of the remanufactured product is set separately from the initial remaining ink amount of the new product. Furthermore, if, after the remanufactured product is installed, the remanufactured-product remaining amount 124 exceeds the retrieved remanufactured-product initial remaining amount 122, this may indicate that the remanufactured-product remaining amount 124 has been improperly altered to a remaining amount Vc greater than the predefined remanufactured-product initial remaining amount 122. Thus, if the remanufactured-product remaining amount 124 is greater than the remanufactured-product initial remaining amount 122, the execution of the processing from S31 onward, including S35, in FIG. 7C is restricted, thereby suppressing unauthorized use of the cartridge 100.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

For instance, the configuration of the printer 10 described in the aforementioned illustrative embodiment is merely an example. Feasible configurations of the printer 10 according to aspects of the present disclosure are not limited to inkjet-type printing apparatuses, but may also include electrophotographic printing apparatuses. Accordingly, feasible examples of the replaceable component according to aspects of the present disclosure are not limited to ink cartridges, but may also include toner cartridges. Additionally, feasible examples of the consumable material according to aspects of the present disclosure are not limited to ink, but may also include toner. In such cases, a memory disposed on each toner cartridge may store consumable initial-state information regarding an initial state of the toner, such as a new-product initial remaining amount 121 of the toner. Moreover, feasible examples of the printing apparatus according to aspects of the present disclosure may include apparatuses configured to perform printing using other printing methods, such as thermal transfer or thermal printing. Accordingly, the replaceable components or consumables according to aspects of the present disclosure may include ink ribbons, thermal paper, or other storage members for such consumables. Additionally, the ink 101 may be stored in a container (e.g., a bottle) other than the cartridge 100. In such a case, the container configured to store the ink 101 is an example of the replaceable component according to aspects of the present disclosure. In the aforementioned illustrative embodiment, the printer 10 has been used as an example of the printing apparatus according to aspects of the present disclosure. However, feasible examples of the printing apparatus are not limited to this configuration and may also include a so-called multifunction peripheral (hereinafter referred to as an “MFP”) having functions such as facsimile, scanning, and copying. Additionally, the printer 10 may be configured without including the sub-tanks 37. Furthermore, feasible examples of the replaceable component according to aspects of the present disclosure are not limited to components configured to store unused consumables, such as the cartridge 100, but may also include a waste liquid tank configured to store used consumables, such as waste ink 101. For instance, the printer 10 may include a replaceable waste liquid tank configured to store waste liquid generated during cleaning processes of the nozzles 19. The printer 10 may be configured to retrieve, from a memory disposed on the waste liquid tank, information regarding the initial state of the waste liquid tank-such as the storable amount of ink, the amount of ink currently stored, and parameters for calculating the stored amount-and to perform processing related to waste liquid based on the retrieved information. For instance, the controller 30 may determine the replacement timing of the waste liquid tank based on the retrieved information and provide a corresponding notification to the user. In such a case, the printer 10 may also include a sub-tank connected to the waste liquid tank.

Furthermore, the printer 10 may be configured without the network I/F 51. The controller 30 may include a SoC (“SoC” is an abbreviation for “System on a Chip”) in place of, or in addition to, the ASIC 47. The controller 30 may include a plurality of ASICs 47, and/or a plurality of CPUs 43. In another instance, the controller 30 may be configured without the CPU 43. In such a case, the controller 30 may be configured to execute various control programs on the ASIC 47.

Additionally, the order and contents of the flowcharts shown in FIGS. 6 to 11 are merely examples. For instance, the controller 30 may execute only one of SI or S3 in FIG. 6. Further, in the processing shown in FIG. 6, the controller 30 may execute S8 prior to executing S5. The controller 30 may execute S8 in response to making a negative determination in S4, and may then execute S5 in response to making a negative determination in S8. The controller 30 may omit the processing from S5 to S11. The controller 30 may omit the processing of S27 in FIG. 7B. Even in such cases, when a new cartridge 100 is installed, the information in the EEPROM 46 may be overwritten. In the aforementioned illustrative embodiment, when authentication in S25 fails (S25: NO), the controller 30 determines that the CTG error state has occurred and skips all processes from S26 onward. However, even in such a case, the controller 30 may execute some (e.g., at least one but not all) of the processes from S26 onward. For instance, the controller 30 may execute the reset process in S10 for a cartridge 100 in the CTG error state.

In the aforementioned illustrative embodiment, the reset count 127 is used to record the number of times the cartridge 100 has been remanufactured. However, feasible usage examples of the reset count 127 are not limited to this usage. For instance, the reset count 127 may instead represent the allowable number of times the cartridge 100 is permitted to undergo remanufacturing (i.e., the reset process shown in FIG. 11). In such a case, the reset count 127 may initially be set to the upper limit (e.g., ten) of the allowable number of times the cartridge 100 is permitted to be remanufactured. Further, when determining whether the cartridge 100 is a new-product cartridge or a remanufactured-product cartridge in S26, S41, S51, or S61, the controller 30 may make such a determination based on whether the reset count 127 is equal to the upper limit. In this case, the controller 30 may determine that the cartridge 100 is a new-product cartridge when the reset count 127 is equal to the upper limit. Meanwhile, the controller 30 may determine that the cartridge 100 is a remanufactured-product cartridge when the reset count 127 is less than the upper limit. Then, in S71, the controller 30 may decrement the reset count 127 by one. After executing S71, the controller 30 may determine whether the reset count 127 is less than zero. If the reset count 127 is less than zero (e.g., −1), the controller 30 may store information indicating that a CTG error state has occurred with the cartridge 100 in, for instance, the memory 110 in substantially the same manner as in S28. This configuration makes it possible to limit the number of times the reset process is permitted for the cartridge 100—i.e., the allowable number of times the cartridge 100 is permitted to be remanufactured.

A value (hereinafter referred to as a “manufacturer's reset count”) indicating the number of times the cartridge 100 has been remanufactured by the manufacturer may be stored in the memory 110 separately from, or in place of, the reset count 127 indicating the number of times the cartridge 100 has been remanufactured by the remanufacturer. In such a case, the processes shown in FIGS. 6 to 11 may be executed using the manufacturer's reset count in substantially the same manner as the remanufacturer's reset count 127. For instance, in S21 of FIG. 7A, the controller 30 may determine whether the cartridge 100 has been replaced based on whether the manufacturer's reset count stored in the EEPROM 46 matches the manufacturer's reset count retrieved from the currently installed cartridge 100. Further, in S26, the controller 30 may determine whether the manufacturer's reset count is equal to or greater than one, thereby selecting whether to determine whether the new-product remaining amount 123 is equal to or less than the new-product initial remaining amount 121 (S29), or whether the remanufactured-product remaining amount 124 is equal to or less than the remanufactured-product initial remaining amount 122 (S30). Additionally, in response to executing the reset process shown in FIG. 11, the controller 30 may increment the manufacturer's reset count by one (S71). The scope of the present disclosure is not limited by the dependency relationships set forth in the claims.

The following provides examples of associations between elements set forth in the aforementioned illustrative embodiment(s) and modification(s), and elements claimed according to aspects of the present disclosure. For instance, the printer 10 may be an example of a “printing apparatus” according to aspects of the present disclosure. Each cartridge 100 may be an example of a “replaceable component” according to aspects of the present disclosure. The liquid chamber 103A of each cartridge 100 may be an example of a “chamber” according to aspects of the present disclosure. The memory 110 of each cartridge 100 may be an example of a “memory” according to aspects of the present disclosure. The attachment case 27 may be an example of an “attachment case” according to aspects of the present disclosure. The controller 30 may be an example of a “controller” according to aspects of the present disclosure. The CPU 43 and the ASIC 47 may be included as examples of a “processor” according to aspects of the present disclosure. The ROM 44 storing the control programs 44a may be an example of a “non-transitory computer-readable instructions” storing “computer-readable instructions” according to aspects of the present disclosure. Each sub-tank 37 may be an example of a “sub-tank” according to aspects of the present disclosure. The new-product initial remaining amount 121, the remanufactured-product initial remaining amount 122, the new-product remaining amount 123, the remanufactured-product remaining amount 124, the cartridge type information 125, the signature information 126, the reset count 127, the ID information 128, the new-product equilibrium calculation parameter 129, and the remanufactured-product equilibrium calculation parameter 130 may be included as examples of “consumable initial-state information” according to aspects of the present disclosure. The processes related to the ink 101 such as S24, S25, S29, S30, S35, S43, S46, S53, S56, S63, S66, S68, and S71 may be included as examples of “consumable processing” according to aspects of the present disclosure.

What is claimed is:

1. A printing apparatus comprising:
a replaceable component comprising:
a chamber configured to store a consumable material used for printing; and
a memory configured to store consumable initial-state information regarding an initial state of the consumable material;
an attachment case configured to hold the replaceable component removably installed thereto; and
a controller configured to:
retrieve the consumable initial-state information from the memory of the replaceable component installed in the attachment case; and
perform consumable processing related to the consumable material based on the retrieved consumable initial-state information.

2. The printing apparatus according to claim 1,
wherein the controller is further configured to retrieve the consumable initial-state information in response to at least one of a first condition or a second condition being satisfied, the first condition being that the printing apparatus is powered on, the second condition being that the replaceable component is installed in the attachment case.

3. The printing apparatus according to claim 2,
wherein the memory is further configured to store identification information for identifying the replaceable component, and
wherein the controller is further configured not to retrieve the consumable initial-state information from the memory, even when the second condition is satisfied, if a third condition is satisfied, the third condition being that the identification information stored in the memory of the currently installed replaceable component matches identification information of a previously installed replaceable component.

4. The printing apparatus according to claim 3,
wherein the memory is further configured to store a reset count indicating a count of times information regarding the installed replaceable component has been reset, and
wherein the controller is further configured to:
not retrieve the consumable initial-state information from the memory, even when the second condition is satisfied, if both the third condition and a fourth condition are satisfied, the fourth condition being that the reset count stored in the memory of the currently installed replaceable component matches a reset count of the previously installed replaceable component; and
retrieve the consumable initial-state information from the memory, when the second condition is satisfied, if at least one of the third condition or the fourth condition is not satisfied.

5. The printing apparatus according to claim 1,
wherein the consumable initial-state information includes an initial amount of the consumable material in the replaceable component, and
wherein the controller is further configured to perform the consumable processing comprising:
calculating a remaining amount of the consumable material in the replaceable component based on the initial amount of the consumable material in the replaceable component; and
outputting a ratio of the remaining amount of the consumable material in the replaceable component to the initial amount of the consumable material in the replaceable component.

6. The printing apparatus according to claim 1,
wherein the controller is further configured to:
perform authentication of the replaceable component based on information stored in the memory of the replaceable component; and
determine whether to perform or restrict the consumable processing depending on whether the authentication succeeds or fails, thereby performing the consumable processing when the authentication succeeds, and restricting the consumable processing when the authentication fails.

7. The printing apparatus according to claim 6,
wherein the consumable initial-state information includes electronic signature information, and
wherein the controller is further configured to perform the authentication of the replaceable component based on the electronic signature information included in the consumable initial-state information.

8. The printing apparatus according to claim 6,
wherein the memory is further configured to store a hash value for the authentication, and
wherein the controller is further configured to determine that the authentication succeeds when a hash value calculated using the consumable initial-state information matches the hash value for the authentication stored in the memory.

9. The printing apparatus according to claim 1,
wherein the memory is further configured to store information indicating whether the replaceable component is a remanufactured product, and
wherein the controller is further configured to change contents of the consumable processing depending on whether the replaceable component is a remanufactured product.

10. The printing apparatus according to claim 1, further comprising a sub-tank configured to connect to the replaceable component installed in the attachment case and to store the consumable material supplied from the replaceable component,
wherein the memory is further configured to store a parameter for calculating an amount of the consumable material in the chamber of the replaceable component installed in the attachment case and an amount of the consumable material in the sub-tank, the parameter being set to a value corresponding to the consumable initial-state information, and
wherein the controller is further configured to retrieve the parameter from the memory and calculate a remaining amount of the consumable material in the chamber of the replaceable component based on the retrieved parameter.

11. The printing apparatus according to claim 1,
wherein the consumable initial-state information includes different types of initial amounts of the consumable material in the replaceable component, the different types including:
a first initial amount set during manufacturing of the replaceable component; and
a second initial amount used when the replaceable component is remanufactured,
wherein the memory is further configured to store a remaining amount of the consumable material in the replaceable component, and
wherein the controller is further configured to:
write the second initial amount into the memory as the remaining amount of the consumable material in the replaceable component when resetting the remaining amount to remanufacture the replaceable component; and
restrict the consumable processing if, after the replaceable component has been remanufactured and installed in the attachment case, the remaining amount of the consumable material in the installed replaceable component is greater than the second initial amount.

12. The printing apparatus according to claim 1,
wherein the controller comprises:
a processor; and
a non-transitory computer-readable storage medium storing computer-readable instructions configured to, when executed by the processor, cause the controller to:
retrieve the consumable initial-state information from the memory; and
perform the consumable processing based on the retrieved consumable initial-state information.
